(19) United States
(12) Patent Application Publication
(10) Pub. No.: US 2020/0163023 A1
(43) Pub. Date: May 21, 2020

(54) METHODS, APPARATUSES AND SYSTEMS FOR ADAPTIVE UPLINK POWER CONTROL IN A WIRELESS NETWORK

(71) Applicant: IDAC Holdings, Inc., Wilmington, DE (US)

(72) Inventors: Ghyslain Pelletier, Montreal (CA); Paul Marinier, Brossard (CA)

(21) Appl. No.: 16/621,611

(22) PCT Filed: Jun. 12, 2018
(86) PCT No.: PCT/US18/37000

§ 371 Date: Dec. 11, 2019

Related U.S. Application Data
(60) Provisional application No. 62/586,462, filed on Nov. 15, 2017.
(60) Provisional application No. 62/555,401, filed on Sep. 7, 2017.
(60) Provisional application No. 62/542,443, filed on Aug. 8, 2017.
(60) Provisional application No. 62/519,365, filed on Jun. 14, 2017.

(51) Int. Cl. H04W 52/14; H04W 52/34; H04W 72/04

(52) U.S. Cl. CPC H04W 52/146; H04W 72/042; H04W 52/346

(57) ABSTRACT

The disclosure pertains to methods, apparatuses, and systems directed to adaptive uplink power control in a wireless network. In an embodiment, the WTRU obtains a maximum transmit power level assigned for the WTRU. The WTRU identifies first and second groups of transmissions for transmission by the WTRU on an uplink, determines a first guaranteed power level for the first group of transmissions and a second guaranteed power level for the second group of transmissions, adjusts one or both of the first and second guaranteed power levels based on one or more previous activities of the WTRU and the obtained maximum transmit power level assigned for the WTRU, and transmits the first and second groups of transmissions at least at the first and second guaranteed power levels, respectively.

### BACKGROUND

Mobile communication is in continuous evolution and is already at the doorstep of its fifth incarnation, which is called, 5th Generation (“5G”). As with previous generations, new use cases have been proposed in connection with setting of requirements for the new system.

Such 5G system may correspond at least in part to a New Radio access technology (“NR”) that meets 5G requirements.

The NR access technology may be expected to support a number of use cases such as enhanced Mobile Broadband (eMBB), ultra-high reliability and low latency communications (URLLC), and massive machine type communications (mMTC). Each use case comes with its own set of requirements of spectral efficiency, low latency and massive connectivity, for example. The NR access technology may be also expected to have an uplink power control mechanism for power allocation.

### SUMMARY

Methods, apparatuses, and systems directed to adaptive uplink power control in a wireless network are provided. The methods, apparatuses, and systems may include sharing a WTRU's total available power for uplink transmissions. In some embodiments, the total available power for uplink transmissions may overlap at least partly in time, for example, when scheduling information for at least one transmission may not yet be available (e.g., due to significant differences in timeline and/or due to uncoordinated (e.g., multi-node) scheduling, etc.).

### BRIEF DESCRIPTION OF THE DRAWINGS

A more detailed understanding may be had from the detailed description below, given by way of example in conjunction with drawings appended hereto. Figures in the description, are examples. As such, the Figures and the detailed description are not to be considered limiting, and other equally effective examples are possible and likely. Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram illustrating representative power allocation based on network-based and WTRU-based approaches;

FIG. 3 is a block diagram illustrating an overview of Power Control Mode (PCM) 1 representative dynamic sharing approach;

FIG. 4 is a block diagram illustrating an overview of PCM 2 representative power reservation approach in addition to PCM 1 operation and PCM 2 operation;

FIG. 5 is a diagram illustrating a representative power allocation for one or more cell groups (CGs);

FIG. 6 is a diagram illustrating representative partially overlapping transmission for a plurality of CGs on a timeline;

FIG. 7 is a diagram illustrating a representative power configured split;

FIG. 8 is a block diagram illustrating a representative transmission in dual connectivity (e.g., based on Long Term Evolution (LTE) and NR);

FIG. 9 is a diagram illustrating a representative dynamic uplink power control procedure having a varying remaining power; and

FIG. 10 is a diagram illustrating a representative dynamic uplink power control procedure having a constant remaining power.

### DETAILED DESCRIPTION

### 1 General Communication Systems

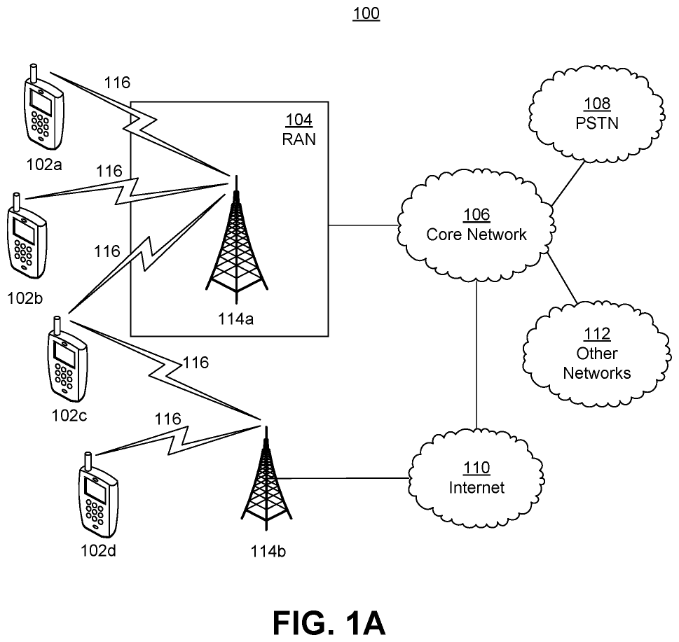

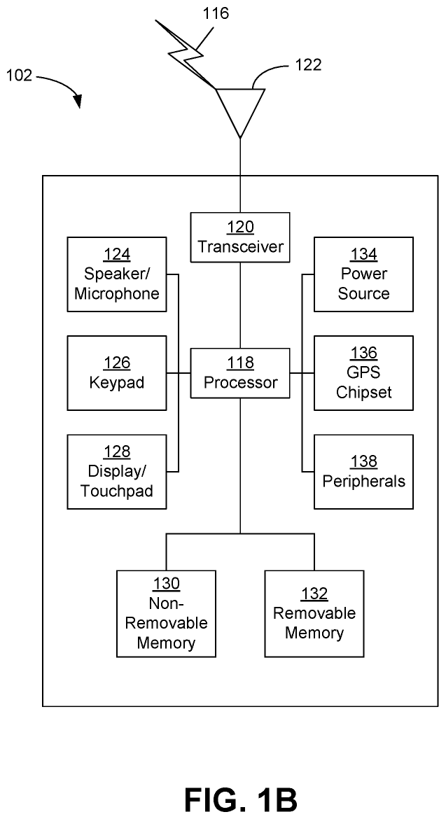

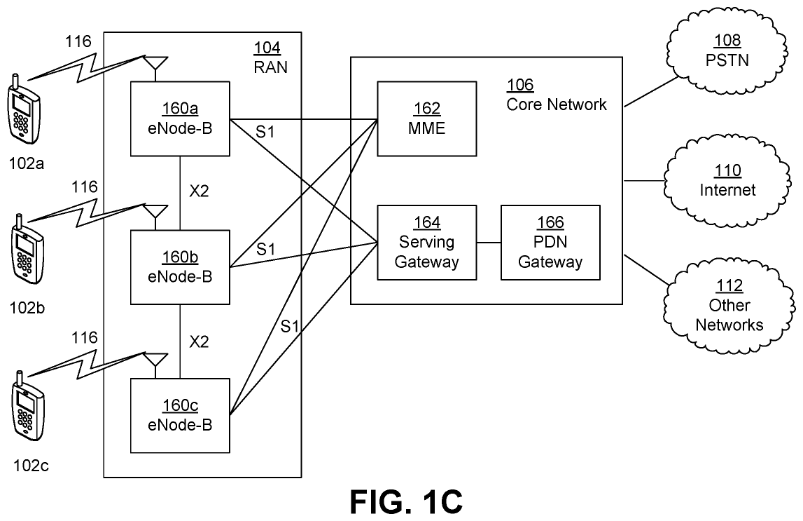

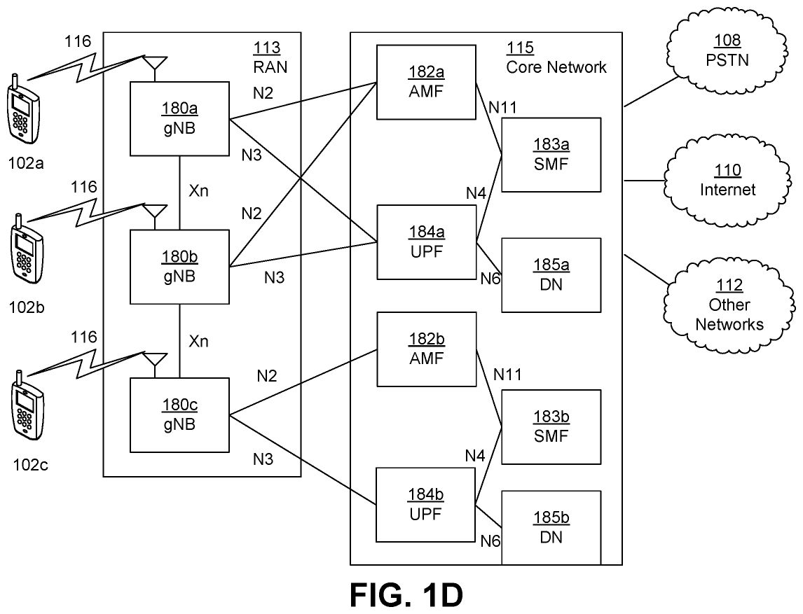

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 ora different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

2 Power Control with Dual Connectivity (DC)

In a wireless network (e.g., LTE), a WTRU may determine transmission power for a type of transmission as a function of desired receive power, Po, (e.g., which may be signaled within system information for a given cell) that is, for example, the power necessary to compensate for propagation loss, PL (e.g., based on an estimated path loss estimation, etc.). PL is a downlink pathloss estimate calculated by the WTRU in dB, and PL=referenceSignalPower−higher layer filtered Reference Signal Received Power (RSRP), where referenceSignalPower is provided by higher layers and RSRP corresponds to the average power of Resource Elements (RE) that carry cell-specific Reference Signals (RS).

This may include a further unit/fractional compensation coefficient ∞ in case of a physical uplink shared channel (PUSCH), an offset amount of power to meet a certain error rate and/or SINR, e.g., Δformat (e.g., for hybrid automatic request (HARQ) Acknowledgment/Negative acknowledgement, Service Request (SR), Channel Quality Indicator (CQI) or combination on a physical uplink control channel (PUCCH)) or ΔMCS (Modulation and Coding Scheme, e.g., for the PUSCH), a component as a function of the number “M” of RBs used for the transmission for the PUSCH, and a correction based on reception of transmit power control (TPC) from the network ∂ (typically +/−1 dB, 0 or 3 dB), etc. In some embodiments, the WTRU may include a sum of previous quantities in determining a transmission power.

In certain embodiments, in a wireless network (e.g., LTE), the WTRU may determine transmission power for a PUCCH (e.g., without a PUSCH) according to something similar to the following: PPUCCH=fct(Po, PL, Δformat, ∂=ΣTPC).

In certain embodiments, in a wireless network (e.g., LTE) the WTRU may determine transmission power for a PUSCH (e.g., without a PUCCH) according to something similar to the following: P_{PUSCH}=fct(Pₒ, ∞ PL, 10 log₁₀(M), ΔMCS, ∂=ΣTPC).

### 2.1 Overview of Power Control Operations for DC

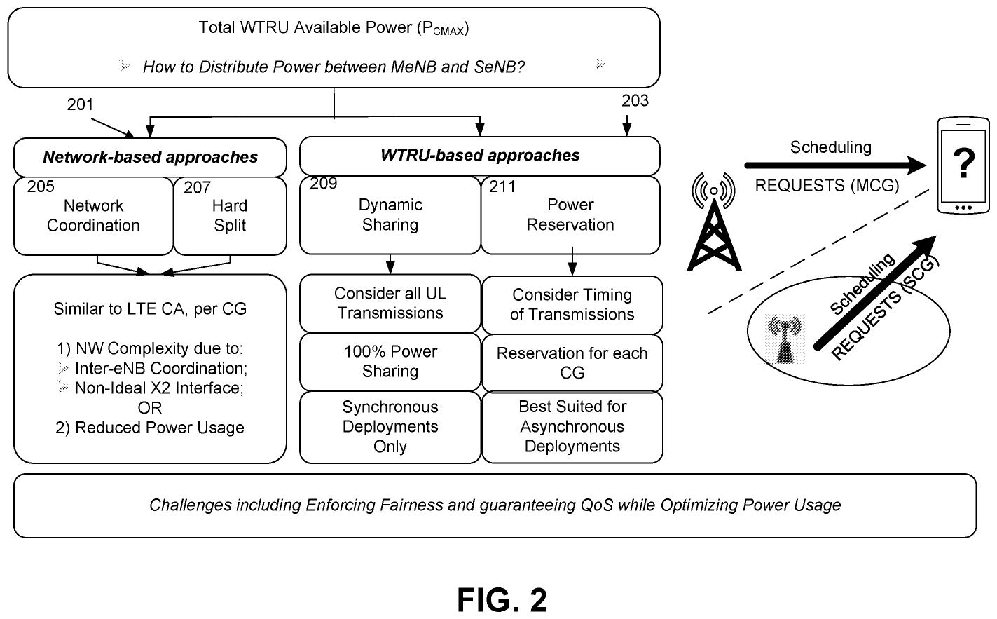

FIG. 2 is a block diagram illustrating representative power allocation schemes. The FIG. describes different possible approaches for distributing total UE available power to different transmissions that may at least partly overlap in time. Those approaches may be categorized as network-based approaches 201 or WTRU-based approaches 203. With network-based approaches, the network may be implemented to perform real-time coordination between different schedulers to minimize the risk of the total UE required transmission power exceeding the total UE available power (205) or, alternately, the network may simply configure the WTRU with a fixed split of the total available power (207). The former may be complex, costly and impractical while the latter may be inefficient in maximizing the use of the WTRU's total available power at any given time.

With WTRU-based approaches 203, the WTRU may implement some form of dynamic sharing 209 of the WTRU's total available power between different sets of transmissions or implement some form of power reservation 211 mechanism such that a minimum fraction of the total WTRU's available transmission power may always be available to a given set of transmissions. The former may enable the most efficient sharing of the total WTRU's available transmission power when the start time of all applicable transmissions is within a short time interval as for synchronous network deployments, while the latter may be better suited for other cases. There may be a number of possible procedures to allocate a total WTRU available power (e.g., P_{CMAX}) to different transmissions in the presence of independent scheduling instructions.

In some embodiments, two types of power control modes (PCMs) may be defined, mode 1 and mode 2. A WTRU capable of DC may support at least PCM 1 and the WTRU may additionally support PCM 2. In both modes, the WTRU may be configured with a minimum guaranteed power for each cell group (CG) as a ratio of the total available power P_{CMAX}.

### 2.1.1 PCM 1—Dynamic Sharing Operation

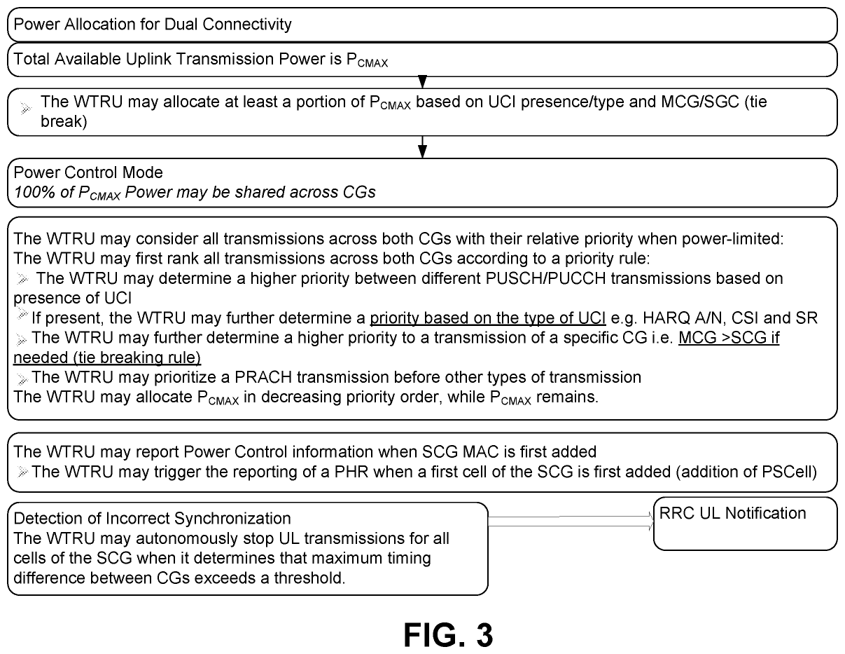

In some embodiments, in power control mode (PCM) 1, a WTRU may first allocate up to a minimum guaranteed power to a CG, (e.g., each CG) and then any remaining power may be shared across a Master CG (MCG) and Secondary CG (SCG) on a per transmission basis, for example according to a priority order based on uplink control information (UCI) type, as illustrated in FIG. 3.

FIG. 3 is a block diagram illustrating an overview of a PCM 1 representative dynamic sharing operation. Referring to FIG. 3, the WTRU may consider transmissions (e.g., all transmissions) across both CGs with their relative priority, for example, when power is limited. The WTRU may report power control information, for example when SCG Medium Access Control (MAC) is first added. The WTRU may autonomously stop uplink transmission for cells, (e.g., all cells) of the SCG when it determines that the maximum timing difference between CGs exceeds a threshold.

### 2.1.2 PCM 2—Power Reservation Operation

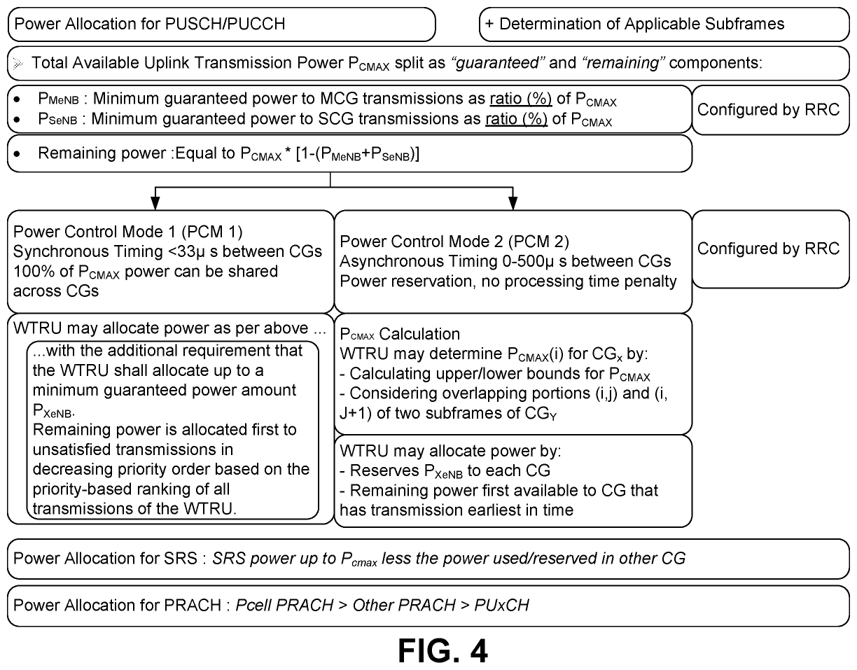

In some embodiments, in PCM 2, a WTRU may reserve a minimum guaranteed power to a CG (e.g., each CG) (e.g., master cell group (MCG) and/or secondary cell group (SCG)) and any remaining power may be first made available to the CG that starts the earliest in time, as illustrated in FIG. 4.

FIG. 4 is a block diagram illustrating PCM 2 representative power reservation procedure in addition to the PCM 1 operation and PCM 2 operation. Referring to FIG. 4, a total available uplink transmission power may be split as “guaranteed” and/or “remaining” components. A power level for each of the uplink transmissions (e.g., PUSCH, PUCCH) may be allocated according to a PCM operation. A specific PCM operation may be configured by a network, e.g., via radio resource control (RRC) signaling. The PCM 1 operation may be applicable in a synchronized deployment, e.g., with less than a specific threshold, e.g., 33 μs between CGs. Differently from the PCM 1 operation, the PCM 2 operation may be applicable in an asynchronous deployment, e.g., with possibly more than a first specific threshold (e.g., 0 μs) but less than a second specific threshold, e.g., 500 μs between the CGs.

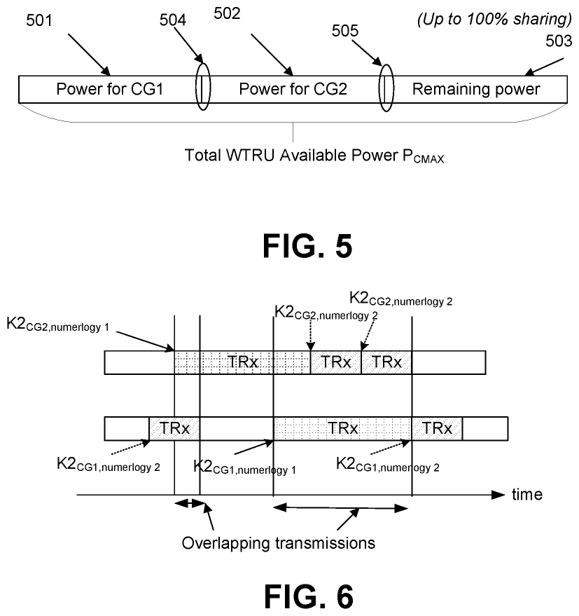

FIG. 5 is a diagram illustrating a representative power allocation for one or more CGs. Referring to FIG. 5, different portions (e.g., a power portion for CG1 501, a power portion for CG2 502, and a remaining power portion 503) of a total WTRU available power are shown in terms of a minimum guaranteed power for the CGs (e.g., each CG). The minimum guaranteed power for the CGs (e.g., each CG) may be a fraction of the total WTRU available power. The total WTRU available power may be indicated by PCMAX as shown in the FIG. 5. A boundary for each portion is indicated with a circle (e.g., 504 and 505) in FIG. 5. The boundary for each portion (e.g., a minimum guaranteed power for CG1 and a minimum guaranteed power for CG2) may be configured, for example by L3 signaling such as RRC signaling. A value for the boundary for each portion (e.g., 504 and 505) may be semi-statically configured. The sum of the boundary for all CGs (e.g., 504 and 505) may or may not be less than 100% of the total WTRU available power and, if less than 100%, a remaining power may be a non-zero value.

### 3 NR Access Technology

In some embodiments, the NR access technology may support carrier aggregation (CA) and dual connectivity (DC). In certain embodiments, in the DC configuration, the NR may act as a secondary cell or as an aggregated cell in conjunction with an LTE cell and/or aggregated cells. This scenario may be referred to as non-standalone (NSA) NR operation. The NR may be an anchor in DC and may use some form of standalone operation (SA).

In other embodiments, the NR access technology may support operation with more than one subcarrier spacing value, where the value may be derived from 15 kHz by multiplication and/or division by a power of 2. Such operation may be referred to as “scalable numerology.”

In some embodiments, a WTRU supporting NR access technology (“NR WTRU”) may use one “reference numerology” in a given NR carrier, for example, which may define a duration of a subframe for the give NR carrier. For example, the duration of a subframe in NR for a reference numerology with subcarrier spacing (2^{m}*15) kHz may be exactly ½^{m} ms, may be more than ½^{m} ms, or may be less than ½^{m} ms.

In some embodiments, the NR access technology may support multiplexing numerologies in time and/or frequency within a subframe or across subframes from a WTRU perspective.

In some embodiments, a frame structure of NR may be defined as a “slot”. A slot may have a duration of a number y of OFDM symbols in a numerology used for one or more transmissions. An integer number of slots may fit within one subframe duration, for example at least when the subcarrier spacing is larger than or equal to that of the reference numerology. In another embodiment, the frame structure of NR may also be defined as a “mini-slot”, having a transmission shorter than y OFDM symbols.

Methods, apparatus, and systems for uplink power control in NR may meet the following use cases and be applicable to any other embodiments, use cases and/or wireless technology:

standalone NR with single carrier operation (e.g., with single numerology and/or multiplexed numerology);

NR carrier aggregation multiplexed numerology (e.g., in a same carrier and/or in different carriers). In some embodiments, the NR carrier aggregation multiplexed numerology may be in a same band or different bands, for example, in case of different carriers;

NR in DC with different numerologies; and/or

interworking between different radio access technologies (e.g., LTE and NR) with same or different numerologies.

### 4 Supplementary Uplink (SUL) Carrier

A UE may be configured with a cell with a primary uplink (PUL) carrier and/or a supplementary uplink (SUL) carrier. In a representative embodiment, a cell (e.g., in NR) may be configured with one or more supplementary uplinks. The terms “PUL” and “SUL” in this disclosure may be used to refer to a primary uplink carrier and supplementary uplink carrier, respectively.

One motivation for the use of SUL may be to extend the coverage of a UE operating in different frequencies. For example, the UE may be configured to be operating in a higher frequency for a first uplink carrier (e.g., a primary uplink (PUL) carrier), such that the UE may perform transmissions on the SUL when the SUL is configured as a second uplink carrier in a lower frequency band. This may be useful, e.g., in particular, when the UE moves toward the edge of the coverage of the cell's primary uplink carrier. Another possible use of the SUL may be to provide specific services, higher throughput, and/or increased reliability, among others. For example, the UE may be configured to perform transmissions on multiple uplinks for multiple cells concurrently (or near concurrently, e.g., in a TDM fashion).

In some representative embodiments, the SUL may be modeled (e.g., in NR) as a cell with a downlink carrier associated with two separate uplink carriers. The uplink carriers may consist of a PUL and a SUL. For example, the PUL may be in a high frequency band where the downlink carrier is also located, and the SUL may be in a lower frequency band.

One or more SULs may be configured for any type of cell, e.g., including (but not limited to) a primary cell (PCell), a secondary cell (SCell), and/or a Secondary PCell (SPCell) for dual connectivity. In a representative embodiment, a SUL may be configured for a UE operating using a connection to a single cell and/or when configured for dual connectivity. In another representative embodiment, the SUL may be configured for a UE operating in a cell of a multi-RAT dual connectivity system.

The UE may perform initial access to a cell using, e.g., PUL and/or SUL. The configuration information of the SUL may be broadcast in the system information (SI) for a cell (e.g., the minimal SI corresponding to the minimal information that the WTRU needs to access the cell and/or to camp on the cell). For example, the UE may select the SUL for initial access if the downlink quality of the serving cell is below a threshold. The threshold may be pre-configured.

There may be different operating modes for the SUL associated with a UE in RRC Connected mode.

In certain representative operation modes, an RRC (e.g., RRC protocol) may configure the UE with multiple uplinks. In some representative embodiments, one uplink may be a PUL with a typical uplink configuration for a cell and/or another uplink may be the SUL, which may minimally include a sounding reference signal (SRS) configuration. In such a mode of operation, the UE may use the PUL for control and data transmission (e.g., all control and data transmission) in the uplink. The UE may transmit (e.g., additionally transmit) SRS using resources of the SUL. In some representative embodiments, the RRC reconfiguration may provide an extended, typical, and/or possibly complete, uplink configuration with a different carrier, e.g., to activate and/or to switch the applicable active uplink carrier for the cell for some or all transmissions.

In certain representative operation modes, the RRC (e.g., RRC protocol) may configure multiple uplinks (e.g., with an extended, typical, and/or possibly complete uplink configuration). In some representative embodiments, the UE may have one or more configurations (e.g., sufficient configuration(s)) to perform some or all types of uplink transmissions (e.g., PUCCH, PUSCH and/or PRACH transmissions) on resources of one or more carriers. In some representative embodiments, the UE may receive (e.g., subsequently receive) control signaling (e.g., a MAC Control Element and/or a DCI), e.g., that may activate and/or may initiate a switch between the UL configurations.

In certain representative operation modes, the RRC (e.g., RRC protocol) may configure multiple uplinks where the configuration of two (or more) uplinks may be active either concurrently or in a time-division fashion. In some representative embodiments, this mode of operation may include a restriction such that the UE may not perform and/or may not be required to perform some or all types of uplink transmissions, simultaneously. For example, the UE may not transmit and/or may not be required to transmit a PUSCH for the cell simultaneously on multiple uplink carriers. In some representative embodiments, the restriction may be configured for the UE, e.g., in particular, when the UE's capability indicate that the simultaneous transmissions are not supported for, e.g., the configured frequency bands.

In some representative embodiments, for transmissions (e.g., each transmission) a WTRU may perform and/or make a determination (e.g., decision) of power allocation that may be based on one or more of the following factors:

scheduling information (e.g., downlink control information (DCI) for dynamic scheduling, a configured grant for semi-persistent allocation, and/or information for an unscheduled transmission) of one or more transmissions;

path loss measurements and/or estimation (e.g., applicable to resources associated with the one or more transmissions);

available transmission power (e.g., as determined from P_{CMAX}); and/or

any ongoing and/or scheduled transmission(s) that may overlap at least partly in time with the one or more transmissions.

In some embodiments, the above-described factors may be related to allocation of transmission power to one or more transmissions performed at a given time.

### 5 Representative Challenges Related to Uplink Power Control

Challenge 1: Transmissions may overlap in time such that a fraction of an available power may need to be determined.

More particularly, transmissions may be performed such that they may at least partially overlap in time. In such a case, a WTRU may allocate a portion of a total WTRU available power to the transmissions. In certain embodiments, such total WTRU available power may correspond to a P_{CMAX} value. For example, such total WTRU available power may correspond to a P_{CMAX} value minus a power level already assigned to other, e.g., possibly ongoing, transmissions. For example, the P_{CMAX} value may be calculated as a function of an applicable waveform, numerology and/or frequency band associated with the transmission. For example, the P_{CMAX} value may be calculated as a function of regulatory requirements related to out-of-band emission, Specific Absorption Rate (SAR), applying (P-)MPR, beam quality or the like.

Challenge 2: Transmissions may have different transmission characteristics, e.g., duration and/or reliability requirements. Transmission characteristics may be significantly different.

More particularly, transmissions may be associated with different characteristics. For example, the characteristics may include the duration of transmission, a specific timeline, e.g., a HARQ timeline, a type of physical channel, a set of physical resources, a type of HARQ processing, a priority (e.g., relative to other transmissions), a specific power requirement (e.g., power boosting and/or TPC indication for reliability), a transmission reliability target, an indication and/or an association with a specific type of data and/or logical channel/bearer, and/or a configuration thereof among others. The one or more characteristics may be referred to as a profile of the transmission, e.g., a transmission profile.

Challenge 3: Transmissions may have different scheduling characteristics, e.g., CORESET, BandWidth Part (BWP), uncoordinated schedulers, timelines, etc. Scheduling characteristics may be significantly different.

More particularly, such transmissions may be associated with different scheduling characteristics. In certain embodiments, the characteristics may include a set of physical control channel resources (e.g., CORESET(s)) for DCI that schedules the transmission (if applicable)), the timing between the reception of the DCI and the start of the transmission, the timing between the transmission of a transport block and the transmission of the transport block associated feedback (e.g., this timing being referred to as K2), the set of physical resources associated with scheduling (e.g., the CG associated with the DCI in case of dual connectivity), a BWP or the like. Such characteristics may be included in the characterization of the transmission profile. In some embodiments, a BWP may correspond to a set of contiguous physical resource blocks (PRBs) that may be characterized by a specific numerology, a specific bandwidth (e.g., number of PRBs) and a specific frequency location (e.g., center frequency). The WTRU may be configured with one or more BWP for a given carrier and/or cell.

FIG. 6 is a diagram illustrating representative partially overlapping transmission for a plurality of CGs on a timeline. Referring to FIG. 6, different groups of transmissions that at least partially overlap in time are shown. For example, K2_{CG2, numerology 1} may indicate a first transmission duration (e.g., a TTI) for transmission of CG2. K2_{CG2, numerology 2} may indicate a second transmission duration (e.g., a TTI) for transmission of CG2. K2_{CG1, numerology 1} may indicate the first transmission duration (e.g., a TTI) for transmission of CG1. K2_{CG1, numerology 2} may indicate the second transmission duration (e.g., a TTI) for transmission of CG1. The first transmission duration (e.g., a TTI) may be different from the second transmission duration (e.g., a TTI). Different transmissions may have different timelines in terms of, e.g., transmission duration and/or HARQ round trip time (RTT). A respective timeline may be expressed in terms of one or multiple mini-slots, slots, or subframes as well as in terms of K2. In some representative embodiments, K2 may correspond to a time between a reception of scheduling information (e.g., DCI) and a start of a transmission of a transport block. K2 may correspond to a time between such transmission of a transport block and the transmission of its associated feedback. K2 may correspond to a time duration (e.g., TTI) that may be applicable to the transmission. The different timelines may be considered as a general case of asynchronous deployment. The different timelines may be impacted by different reception timing for grants of the transmissions and/or by processing times (e.g., insufficient processing times, for example for shorter transmission durations).

Challenge 4: Transmissions may be associated with different network nodes and/or RATs.

The transmissions may be scheduled by a single network node, e.g., such that transmissions requirements for a given WTRU may be coordinated by a single scheduler. One challenge may be related to power control and may happen when the transmissions are scheduled by different network nodes such that coordination may not be possible in terms of power control. In some embodiments, a WTRU may be configured with dual connectivity (e.g., with more than one cell group). For example, a WTRU may support LTE Dual Connectivity, NR Multi-Connectivity, and/or LTE with NR tight interworking.

The above-described challenges may be addressed separately or in combination. In certain embodiments, LTE or another technology may support PCM 1 and PCM 2 for uplink power control for dual connectivity. A network may control a WTRU for power allocation by configuring which power control mode, PCM 1 or PCM 2, is to be used on the WTRU.

In some embodiments, PCM 1 may define relative priorities, for example based on a type of transmission (e.g., priority rank of transmission channels: physical random access channel (PRACH)>PUCCH>PUSCH) and/or based on a type of cell group in case of transmissions of the same type (e.g., Master CG>Secondary CG) for transmissions that start within a threshold (e.g., less than 33 μsec) from each other. PCM 1 may enable sharing of up to 100% of the total WTRU available power (e.g., P_{CMAX}).

In some embodiments, PCM 2 may define guaranteed power for transmission associated with each configured CG, for example, as a fraction of the total WTRU available power (e.g., P_{CMAX}). Any remaining power may be assigned to transmissions of the CG whose transmissions start first in time. PCM 2 may enable guarantees of a share of the total WTRU available power at the expense of leaving some power that would have otherwise been useful unused in some cases.

### 5.1 Representative New Challenges for Uplink Power Control on NR

The above described four challenges may be addressed in combination with each other in NR (e.g., and possibly for LTE as well). In some embodiments, support for different transmission time interval (TTI) durations (both in LTE and NR, and combinations thereof), different and possibly varying HARQ timelines, and/or different numerologies (LTE with NR and stand-alone NR) and support for different data services (e.g., URLLC, and/or eMBB, etc.) possibly enabling different transmission profiles at physical layer processing in combination for a given WTRU possibly further configured with carrier aggregation and/or dual connectivity may lead to an even more complex challenge from a perspective of efficiently using the total WTRU available power. Possible impact from using beamforming, if applicable, may be added to this list of complications.

In some embodiments, shorter transmission duration and scheduling/HARQ timelines may make operation impractical (e.g., impractical to implement and process scheduling information in time to perform a transmission), and/or may lead to prohibitive implementation costs.

In other embodiments, it may be more challenging for the WTRU to prioritize between different transmissions and/or to apply a guaranteed amount of the total WTRU available power to a given set of transmissions. This challenge may be attributable to a scheduling applied to the concerned transmissions, such as through dynamic variations in HARQ-related timelines (e.g., varying the time between reception of grant information and start of transmission and/or between the end of a transmission and the start of the transmission of related HARQ feedback, etc.). It also may be attributable to scheduling of transmissions at least partly overlapping in time but with different transmission durations.

In certain embodiments, efficient power sharing may be implemented to allow a WTRU to use as close as possible to 100% of the total WTRU available power at any given time and ensure that the system can perform well for offered procedures services.

### 6 Representative Adaptive Power Allocation Procedures

In some embodiments, the following representative adaptive power allocation schemes may be applicable and may be used independently or in various combinations with each other. Additionally, these adaptive power allocation procedures may be applied to and/or used in combination with other pre-existing power allocation procedures (e.g., LTE PCM 1 and/or PCM 2).

### 6.1 Representative Configuration Aspects

For example, a WTRU may be configured (e.g., via RRC or other signaling) with one or more of the following four power control algorithms (or variations thereof), each of which is described in more detail further below, and each of which may be best suited for a different type of network deployment scenario, e.g., whether the start of transmissions are synchronous or asynchronous and/or scheduling strategy (e.g., whether or not the transmissions are of the same duration and/or have similar HARQ timing).

PCM 1 (Power Sharing, Synchronous Operation):

This PCM 1 (or a variant thereof, possibly including operations described herein) may be useful for cases characterized by transmissions (e.g., all transmissions) that have a similar numerology and/or transmission (e.g., TTI) duration, such as a WTRU configured for LTE Dual Connectivity, for NR Dual/Multi Connectivity, and/or for LTE and NR tight interworking. In embodiments, this PCM 1 may be used in synchronized deployment scenarios, e.g., with less than a specific threshold, e.g., 33 μs between the start of overlapping transmissions.

PCM 2 (Power Reservation, Asynchronous Operation):

PCM 2 (or a variant thereof, possibly including operations described herein) may be useful for a WTRU configured for LTE Dual Connectivity, for NR Dual/Multi Connectivity, for LTE and NR tight interworking where cases may be characterized such that transmissions (e.g., all transmissions) have a similar numerology and/or transmission (e.g., TTI) duration. In embodiments, this PCM 2 may be applicable in an asynchronous deployment, e.g., with possibly more than a first specific threshold, e.g., 33 μs, but less than a second specific threshold, e.g., 500 μs, between the start of overlapping transmissions.

PCM 3 (Power Configured Split):

PCM 3 based on a fixed split of the available transmission power (e.g., a hard split) may be considered/used for a WTRU configured for LTE Dual Connectivity with Short TTIs configured, NR Dual Connectivity, and for LTE and NR tight interworking where cases may be characterized such that different transmissions may have different numerologies and/or transmission (e.g., TTI) durations. In some embodiments, this PCM 3 may be applicable in an asynchronous deployment, e.g., with possibly more than a first specific threshold, e.g., 33 μs, and less than a second specific threshold, e.g., 500 μs, between the start of overlapping transmissions. While PCM 3 is simple and cost-effective and may be preferable in some configurations, the total available WTRU power may not be shared dynamically and/or as efficiently as possible in this mode.

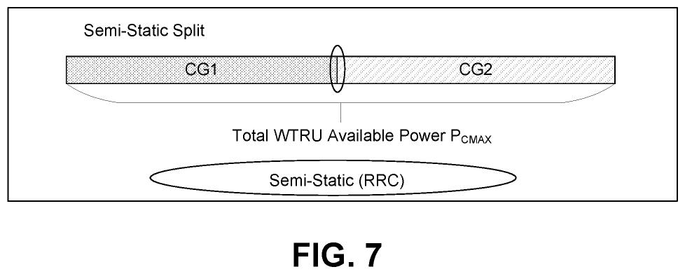

FIG. 7 is a diagram illustrating a representative power configured split of a total WTRU available power. Referring to FIG. 7, the Total WTRU available power may be split between or among a plurality of CGs. For example, the minimum guaranteed transmission power at any given moment (which may be limited to a value that is within a predetermined range at any given moment) for a CG (e.g., each CG) may be set as a percentage of the total WTRU available power. The initial value for the minimum guaranteed transmission power and/or the allowable range for the minimum guaranteed transmission power for each CG may be configured by signaling. For example, it may be configured by L3 or RRC signaling, by L2 or MAC signaling, or possibly by L1 or PDCCH signaling. The total WTRU available power may be indicated by P_{CMAX} as shown in FIG. 7. In certain representative embodiments (e.g., associated with the power configured split case), there may be no remaining power such that it may not be possible to share the remaining power between CGs, for example, at least when transmissions of the CGs overlap between or among each other or among one another. The RRC signaling (e.g., via the RRC) may configure a fixed and/or semi-fixed (e.g., semi-static) split of the available transmission power.

PCM 4 (Dynamic/Adaptive Power Sharing):

PCM 4 may be useful to maximize the WTRU's total available transmission power. PCM 4 may be useful for a WTRU configured with any of the above configurations in terms of multi-connectivity, multi-RAT connectivity, and with support for transmissions of different numerologies and/or transmission (e.g., TTI) durations. PCM 4 may be applicable to any deployment (e.g., synchronized or asynchronous).

Allocating transmission power may be generally based on knowledge of transmission parameters and actual power level required for each transmission (e.g., as in PCM1 and PCM2). In some embodiments, a remaining power portion may be allocated based on knowledge of relative timing of the transmissions with respect to each other (e.g., as in PCM2). A WTRU may be configured to process scheduling information ahead of the allocation of the power level. Priorities and/or applicable guarantees may be either a fixed or semi-static configuration of the WTRU.

### 6.1.1 Representative Transmission Profile

In some embodiments, a transmission profile (TP) may be set and/or defined as a representation of one or more characteristics applicable to a transmission. For example, the characteristics may include any one or more of: (1) a numerology, (2) sub-carrier spacing, (3) a value corresponding to a delay (e.g., N), for example a time between a reception of downlink control signaling (e.g., a DCI) and a start of the transmission, (4) the time between the transmission of a transport block and the transmission of the transport block associated feedback (e.g., K2), and (5) a time duration (e.g., TTI) applicable to the transmission. In some embodiments, a physical layer may be configured to determine an applicable TP as a function of the values associated with a transmission for one or more of the TP characteristics. For instance, the WTRU may be configured with multiple Transmission Profiles (TPs) to choose from, each TP including values for one or more parameters necessary to perform a transmission. When the WTRU receives scheduling information, it may compare the values received for the applicable parameters with those for each stored TP and determine the TP that most closely matches those parameters. Once the TP is known, then the WTRU may group together all of its transmissions corresponding to that TP and the WTRU may have an assigned set of parameters to figure out how much of the total UE available power can be allocated (or is left) for that group.

As an example, TP#1 may correspond to a first numerology (e.g., in terms of subcarrier spacing) combined with a first transmission duration (e.g., a mini-slot) with K2=3, the first transmission duration being 3 mini-slots. As another example, TP#2 may correspond to a second numerology combined with a second transmission duration (e.g., a subframe) with K2=1, the second transmission duration being one subframe, and so on. For example, the characteristics may include one or more parameters for allocating the transmission power (e.g., a power offset/boost component, a priority when setting the power, or the like). The characteristics may include an applicable configuration of a physical layer. For example, the configuration may include an applicable set of physical resource blocks, a type of physical channel, beam-related information, or the like. In some embodiments, beam-related information may correspond to at least one of: (1) a beam (or a set thereof), (2) a beam type or a beam pair link (BPL) identity where a pair may correspond to one downlink beam and one uplink beam. A beam may be further associated with one or more resources for reference signals, for example, Channel State Information-Reference Signal (CSI-RS) (e.g., periodic, semi-static/dedicated, or aperiodic) and/or NR-Synchronization Sequence (NR-SS) (e.g., cell-specific).

In one embodiment, each TP may be assigned an index. The index may identify the transmission profile, may be received in a DCI, and/or may correspond to a specific WTRU process. The WTRU process may, for example, include a determination of what data from what logical channel may be used for multiplexing in a transport block for the transmission. A TP may be characterized as a configuration aspect of the WTRU, e.g., by RRC signaling. The term transmission profile and any of the above characterization may be used interchangeably herein.

### 6.1.2 Representative Group of Transmissions (e.g., Overload as CG, MCG, SCG)

In some embodiments, a group of transmissions may be set and/or defined as one or more transmissions that share some association with each other, such as a transmission characteristic. For example, the one or more transmissions may overlap at least partly in time. For example, the one or more transmissions may correspond to any of: transmissions associated with a set of resources, for example: (1) the resources may correspond to resources of a cell group (CG) (e.g., MCG, SCG)), (2) the resources may be associated with one or more control channel resource sets (CORESET), (3) the resources may be associated with one or more bandwidth part(s) (BWP), (4) the resources may be associated with a MAC entity, (5) the resources may be associated with a transmission profile, and/or (6) the resources may be associated with a specific numerology, time (e.g., TTI) duration, beam-related resources, or a combination thereof. In addition, transmissions may be grouped by the resources that may correspond to a Modulation and Coding Scheme (MCS), to one of a plurality of MCS tables (e.g., such as a MCS table associated to the scheduling of ultra-reliable, low latency transmissions), to a specific RNTI, to one of a plurality of RNTIs (e.g., such as a RNTI associated to the scheduling of ultra-reliable, low latency transmissions). Yet further, transmissions may be grouped by the resources that may correspond to a logical channel (LCH) restriction or mapping of data from a specific LCH as configured for the logical channel prioritization (LCP) procedure.

In some embodiments, beam-related information and/or beam-related resources may correspond to at least one of: (1) a beam (or a set thereof), (2) a beam type, and/or (3) a BPL identity where a pair may correspond to one downlink beam and one uplink beam. A beam may be associated with one or more resources for reference signals, for example, CSI-RS (e.g., periodic, semi-static/dedicated, or aperiodic) and/or NR-SS (e.g., cell-specific). For example, the combination may consist of resources associated with a CG for transmissions of a given transmission profile. Such a combination may consist of or include resources associated with a CG for transmissions using a specific set of beams and/or BPLs.

In some representative embodiments, a WTRU may consider a guaranteed power level (e.g., for reservation of power to a group of transmissions), for example, when the WTRU determines that resources are active (e.g., a corresponding cell and/or carrier is in an activated state, a BWP is in the activated state, and/or a corresponding physical resource (e.g., bandwidth) is being processed by the WTRU at the time of the transmission). In other representative embodiments, a WTRU may consider the guaranteed power level (e.g., for reservation of power to a group of transmissions), for example, when the WTRU determines that the WTRU is decoding a CORESET for scheduling information for a time instant in which a transmission may occur. For example, one or more transmissions may correspond to transmission(s) associated with a transmission profile. For example, the one or more transmissions may correspond to transmission(s) associated with any of: (1) a specific power control loop (e.g., closed power control loop), (2) a WTRU's capability, a specific range of frequencies, and/or a hardware characteristic of the WTRU (e.g., a low or a high frequency RF chain), (3) a specific type of a reference signal (e.g., a CSI-RS, a demodulation (DM)-RS, NR-SS, a SS block, and/or a SS burst set, or the like) and/or a corresponding resource thereof, (4) a specific type of transmission (e.g., a PRACH transmission, a PUSCH transmission, and/or a PUCCH transmission), and/or (5) a format (e.g., specific format such as PUCCH format 1, format 3, or the like). The term group of transmissions and any of the above characterization may be used interchangeably herein.

In some representative embodiments, transmissions may be grouped according to at least one of the followings factors:

processing time
1. In a representative embodiment, transmissions for which a UE's processing time is below (and/or equal to) a threshold may be associated with a first group of transmissions, while transmissions for which the UE's processing time is above (and/or equal to) the threshold may be part of a second group of transmissions. The threshold may be pre-configured. In some representative embodiments, the UE's processing time may be a time between reception of control information (e.g., the grant in a DCI) and a start of the transmission.
2. The processing time may be based on a definition of a range of the processing time. The time range and/or thresholds may be a configuration aspect of the UE and/or may be based on dynamic information, e.g., K2 in the DCI and may, for example, enable a UE's configuration whereby a certain amount of guaranteed power may be allocated for transmissions, e.g., that are scheduled late and/or for which the UE has a particular processing time (e.g., very stringent processing time).

type of scheduling
1. In some representative embodiments, the type of scheduling may include slot-based scheduling and/or non-slot-based scheduling. With regard to slot-based scheduling, for example, the UE may be configured to decode resources of a control channel for scheduling information, e.g., DCI on a PDCCH, using a first timeline (e.g., with a minimum time duration between each occasion equal to the duration of a slot which may be, for example, 0.5 ms, and/or for resources spanning between a few symbols in time). With regard to the non-slot-based scheduling, for example, the UE may be configured with PDCCH occasions of a duration of one or a few symbols following, e.g., a configured pattern within, e.g., a slot and/or a subframe.
2. In some representative embodiments, transmissions according to a first scheduling procedure (or a configuration thereof) may be associated with a first group of transmissions, and transmission associated with a second scheduling procedure may be associated with a second group of transmissions, for example, to enable a UE's configuration whereby a certain amount of guaranteed power may be allocated per scheduling procedure and/or for which the UE may have a particular processing time (e.g., a very stringent processing time).

a type and/or a format of transmission
1. In some representative embodiments, a transmission format for e.g., a PUCCH may be characterized by one or more of: (1) applied transmission coding, (2) multiplexing, (3) scrambling, (4) mapping to physical resources, (5) a number and/or a range of payload, (6) a number of information bits, and/or (7) a selected codebook.
2. In some representative embodiments, a transmission performed according to a first PUCCH format may be associated with a first group of transmissions and a PUCCH transmission performed according to a second PUCCH format may be associated with a second group of transmissions, for example, to enable a UE's configuration whereby a certain amount of guaranteed power may be allocated for transmissions. For example, the first PUCCH format may be expected to have a higher power requirement (e.g., transmission power requirement) than for other formats (e.g., the second PUCCH format).

per type of uplink carrier (e.g., a SUL and/or a PUL)
1. In some representative embodiments, a transmission performed on uplink resources of a PUL may be associated with a first group and transmissions performed on a SUL may be associated with a different group of transmissions, for example, to enable a UE's configuration whereby a certain amount of guaranteed power may be allocated for transmission using a first set of resources (e.g. a SUL) that the UE is expected to use (e.g., while at cell edge).

The above factors to group transmissions may be in combination with one or more of the previously described grouping methods/procedures.

### 6.2 Representative General Principles of Adaptive Power Control

In some embodiments, a WTRU may perform adaptation of one or more parameters that control power allocation for uplink transmissions.

### 6.2.1 Representative Adaptive Power Control

Adaptive Power Control may be applied to some or all of a WTRU's transmissions.

The transmissions may include one or more of a transmission on a physical uplink shared channel (e.g., the PUSCH), a transmission on a physical uplink control channel (e.g., the PUCCH), a transmission on a physical random access channel (e.g., the PRACH), a transmission of a reference signal (e.g., a sounding reference signal, SRS), a sidelink transmission or the like, for example in combination, e.g., when the transmissions, for example, overlap with each other in time.

Adaptive Power Control may be used to determine a power level for a transmission.

In some embodiments, power adaptation may include controlling one or more parameters such as at least one of the following:
a) a target desired power. For example, this may correspond to a desired receive power Pₒ and/or a coefficient applied thereto;
b) a compensation component. For example, this may correspond to a coefficient ∞ (e.g., in case of a PUSCH transmission);
c) an offset amount of power and/or a coefficient applied to a component related to a format of a transmission. For example, this may be an offset used to achieve a certain error rate and/or SINR, e.g., Aformat (e.g., for HARQ A/N, SR, CQI or combination on the PUCCH) or ΔMCS (e.g., the PUSCH);
d) an offset amount of power and/or a coefficient applied to a component related to the number of physical resources of a transmission. For example, this may be applied to a component that corresponds to the number “M” of RBs used for the transmission for the PUSCH; and/or
e) a power adjustment. For example, this may correspond to an offset and/or a scaling factor (e.g., for power boosting). As another example, this may correspond to an adjustment applied to a TPC quantity.

The above-described adaptiveness procedures may be applied to different (e.g., per group) transmissions in terms of the above parameters, (e.g., for the purpose of increasing transmission robustness using power boosting, and/or adapting a necessary power of different transmissions when an amount of power may be shared for a group of transmissions). For example, certain uses or requirements for some transmissions (e.g., initial HARQ transmissions, and/or low priority/best-effort type of transmissions) may be decreased and the power (e.g., the necessary power) for other transmissions (e.g., a transmission nearing the maximum number of HARQ transmissions, higher priority transmissions, low latency transmissions, and/or highly reliable transmissions) may have increased power (e.g., by redistributing allocation of power according to a relative priority of the different transmissions.

In other embodiments, the above-described power adaptation procedures may be applied as a function of scaling when a WTRU is power-limited. Certain embodiments may address different timelines, e.g., for possibly overlapping transmissions and constraints of the WTRU's processing time.

6.2.1.1 Dynamic Adaptation to Parameters that Allocate a Portion of the Total WTRU Available Power Between Different Groups of Transmissions

In some embodiments, one or more parameters may be dynamically adapted and/or controlled such that a WTRU may dynamically determine an applicable guaranteed power (e.g., minimum power level) for a group of transmissions, e.g., PXeNB and/or allocation of remaining power (if any) between different groups of transmissions.

P_{XeNB} may be defined or set as a guaranteed power level for a group of transmissions “x,” where x may be in a range [minimum, maximum] for the number of one or more configured groups of a WTRU's configuration inclusively. For example, the range [minimum, maximum] may be set as [2, 2] for dual connectivity. For example, the range [minimum, maximum] may be set as [2, 4] for dual connectivity where each MAC instance may be configured with 2 different TTI durations. It may be possible to set other values based on different combinations and/or based on the definition used for a group of transmissions.

### 6.2.1.2 Dynamic Changes to a Guaranteed Power for a Group of Transmissions

In some embodiments, a WTRU may dynamically determine a minimum guaranteed power level for a group of transmissions, e.g., P_{XeNB}. This may correspond to a ratio of the total available WTRU transmission power (e.g., P_{CMAX}) for a specific group of transmissions. In certain embodiments, the determination may be performed autonomously by the WTRU, may be controlled by the network from the reception of downlink control signaling, or may be a combination of both. This may be performed according to the descriptions set forth herein.

Dynamic changes to allocation of a remaining power between groups of transmissions

In some embodiments, a WTRU may dynamically determine allocation of the remaining power (if any) between different groups of transmissions. The remaining power level may be determined based on the total WTRU available power (e.g., P_{CMAX}) less the amount of guaranteed power assigned to each group of transmissions. The amount of guaranteed power assigned to each group of transmissions may be semi-static or may vary. In some embodiments, the amount of guaranteed power assigned to each group of transmissions may vary. For example, in accordance with the descriptions set forth herein, variations in either the allocation of remaining power or the determination of the guaranteed power will affect the guaranteed power levels. The determination may be performed autonomously by the WTRU, may be controlled by the network from the reception of downlink control signaling, or may be a combination of both. This may be performed according to the descriptions set forth herein.

In some embodiments, the adaptation may be applied as a function of the transmission profile of transmissions, including a relative priority and/or a sequence in the HARQ transmissions.

In some embodiments, a power allocation algorithm for controlling transmission power for a WTRU may include the following:

the WTRU may autonomously adjust a level of guaranteed power for one or more groups of transmissions;

the level of guaranteed power for a group of transmissions may vary between an upper limit and a lower limit; and/or

the level of power adjustment to apply to a transmission (or to a group thereof) may be a function of previous scheduling activity and/or previous transmissions.

The above-described operations may include the use of a power allocation algorithm for controlling transmission power for a WTRU and may be realized, for example, using the descriptions set forth herein.

### 6.2.1.3 Representative Power Allocation by Dynamic Reservation

In some embodiments, power allocation by dynamic reservation may be dynamically signaled using downlink control information, as described herein:

a) reserved and/or guaranteed power level per group of transmissions (e.g., per CG, transmission profiles, type of transmissions, etc.) may be dynamically modified (e.g., decreased, reset or increased);

b) priorities may have been configured, for example, such that the WTRU may resolve possibly conflicting instructions originating, e.g., from different schedulers; and/or

c) priority related to a “first in time” policy that may be applied based on, e.g., time of reception of the control signaling that schedules (or reserves) the transmissions. For example, a remaining power level may be assigned to transmissions for which a DCI has been received first in time.

6.2.1.4 Representative Power Allocation by Previous Scheduling and/or Power

In some embodiments, power allocation may be a function of any of a previous scheduling activity and/or a previous allocated power, as described hereinafter.

In some embodiments, a WTRU may determine that the amount of guaranteed and/or reserved power (or similar) for a group of transmissions (e.g., per CG, transmission profiles, type of transmissions, etc.) may be modified (e.g., decreased, reset, or increased) between a lower bound (e.g., low_guaranteed_power_bound) and an upper bound (e.g., high_guaranteed_power_bound).

In some embodiments, a WTRU may increase or decrease such an amount as a function of the amount of power effectively previously used for transmissions for the group of transmissions, for example, as an average over a certain amount of time (e.g., using a moving window).

In some embodiments, a WTRU may increase or decrease such an amount as a function of the amount of previously successfully decoded DCIs for a given set of control resources (e.g., a CORESET) for the group of transmissions, for example, as an average over a certain amount of time (e.g., using a moving window).

In other embodiments, the operation of additive increase that is described herein below in section 6.3.1.5.3 may be applied when a WTRU determines that the WTRU has successfully received a DCI for a transmission for a group of transmissions (e.g., per CG, transmission profiles, type of transmissions, etc.) and/or upon another type of event (e.g., transmissions of higher priority than for other groups of transmissions, or some transmissions of the group not being served up to their required power level/scaling event); and/or

In other embodiments, the operation of multiplicative decrease that is described herein below in section 6.3.1.5.7 may be applied when the WTRU determines that is has not successfully received a DCI for a transmission, for a group of transmissions (e.g., per CG, transmission profiles, type of transmissions, etc.), or upon another type of event (e.g., transmissions of higher priority than for other groups of transmissions, or all transmissions of the group being served up to their required power level/no scaling event has occurred for the group).

### 6.2.1.5 Representative Power Allocation by a Transmission Period

In some embodiments, power allocation may be a function of the power allocated to a previous transmission, for example, based on a time relationship in-between as described herein. In certain embodiments, the power requirement/allocation level of a transmission of a given group (e.g., per CG, transmission profiles, type of transmissions, etc.) at time k (e.g., a mini-slot, a slot or a subframe) may be the same as for a previous transmission at time k-x, where x may be fixed (e.g., 5 or 6) or configured (e.g., by RRC signaling).

### 6.2.2 Representative Configuration Aspects and Grouping

In certain representative embodiments, configuration aspects of one or more guaranteed power levels may be implemented, for example, where the sum of all guaranteed power levels is less than or equal to P_{CMAX}.

For example, a WTRU may be configured with one guaranteed power level (e.g., P_{XeNB}) or more than one guaranteed power level (e.g., P_{GUARlow_XeNB} and/or P_{GUARhigh_XeNB}) for a group of transmissions. For example, the WTRU may be configured such that the sum of all configured and/or applicable guaranteed levels is less than (e.g., in case that a remaining power is a non-zero value) or equal to (e.g., in case of no remaining power) the total WTRU available power (e.g., P_{CMAX}) at any given time.

In certain representative embodiments, other configuration aspects of one or more guaranteed power levels may be implemented, for example, where the sum of all guaranteed power levels may be higher than P_{CMAX}. For example, a WTRU may be configured with one guaranteed power level (e.g., P_{XeNB}) or more than one guaranteed power level (e.g., P_{GUARlow_XeNB} and/or P_{GUARhigh_XeNB}) for a group of transmissions. For example, the WTRU may be configured such that the sum of all configured and/or applicable guaranteed levels may at least sometimes exceed the total WTRU available power (e.g., P_{CMAX}). In such a case, the WTRU may apply one or more (e.g., additional) prioritization procedures, for example, to determine which transmission's power or which transmissions' powers to adjust (e.g., scale and/or assign less than an otherwise required power), for example, when the total required transmission power exceeds the total WTRU available power (e.g. P_{CMAX}). For example, the WTRU may be configured with different priorities, for example, as a function of the grouping of the transmissions in accordance with any of the following aspects:

(1) a RAT associated with the transmissions (for example, when there is a plurality of different RAT transmissions (e.g., LTE transmissions and NR transmissions), one RAT transmission may take precedence over one or more other RAT transmissions (e.g., LTE transmissions may have or may always have a higher priority than NR transmissions));

(2) a Cell Group associated with the transmissions (for example, when there are a MCG and a SCG). In some representative embodiments, the MCG may have or may always have a higher priority than the SCG);

(3) a type of data transmission (for example, data transmissions may or may not include control information, e.g., UCI, and/or RRC signaling, or the like). In some representative embodiments, transmissions with control information may have or may always have a higher priority than transmissions without control information);

(4) a type of channel (for example, different types of channels and/or signals such as transmissions on a physical control channel (e.g., a PUCCH, or the like), transmissions on a physical data channel (e.g., a PUSCH or the like) and/or a signal (e.g., a SRS or the like)). In some representative embodiments, a control channel and/or transmissions on the control channel may have or may always have a higher priority than the others); and/or

(5) a type of data service (for example, transmissions that include higher priority data may have or may always have a higher priority for power allocation).

Although it is contemplated that the sum of the guaranteed power is equal to or less than the total WTRU available power, the procedures and/or operations described herein are equally applicable for when the WTRU is configured with the guaranteed power greater than the total WTRU available power with one or more of the above-disclosed prioritization procedures/operations.

In certain representative embodiments, transmissions that are grouped together in a first group based on a first criteria (e.g., belonging to the same cell, or having the same numerology) may be further subdivided into smaller sub-groups based on a second criteria (e.g., a first subgroup of transmissions associated with eMBB services and a second subgroup of transmission associated with URLLC services, or a first subgroup of transmissions of a first transmission duration and a second subgroup of transmissions of a second transmission duration). The minimum guaranteed power that is assigned to the first group (the larger group or super group) may then be subdivided into smaller guaranteed minimum power levels for each of the subgroups. In other words, while the WTRU may be configured with one set or range of guaranteed power levels for a certain group of transmissions (e.g., P_{XeNB}, and/or a range thereof), in certain embodiments, subgroups within that group may be each assigned a set or range of guaranteed power levels (e.g., P_{XeNB_eMBB}, P_{XeNB_URLLC}.

Transmissions may be grouped by cell, by BWP, by a specific CORESET, or the like. For example, sets (e.g., each set) of minimum guaranteed power levels for a group of transmissions may correspond to one or more additional aspects related to transmission grouping (e.g., QoS of data, logical channel (LCH), transmission profile indication, and/or data service, or the like). For example, the WTRU may determine an applicable guaranteed power level as a function of certain aspects of the transmissions, and may use the determined guaranteed power level to allocate power for the transmissions. This may be applicable, for example when transmissions are grouped per cells of e.g., the WTRU's configuration and/or when the WTRU can determine such one or more additional aspects of the scheduled transmission. For example, in such a case, the WTRU may adjust the guaranteed power levels per set of guaranteed power levels. The WTRU may dynamically adjust the guaranteed power levels per set of guaranteed power levels, for example if such dynamic adaption is supported. This may be particularly applicable when the sum of applicable levels (e.g., all applicable levels) may at least sometimes exceed the total WTRU available power.

In some representative embodiments, configuration aspects of guaranteed power levels with respect to multiple types of groups may be implemented. For example, the WTRU may be configured with a plurality of groups of transmissions, where one or more groups may be of a different type (e.g., a different group type) than other groups. The WTRU may be configured such that a group type may supersede one or more other group types. For example, the WTRU may be configured with a transmission group for preamble transmissions in addition to one or more groups of transmissions of a different type (e.g., such as other groups per cell). In such a case, the WTRU may perform the transmission of a preamble (e.g., associated with a transmission group “A”) on resources of a cell of a SCG (e.g., which transmissions are otherwise associated with a transmission group “SCG”) and apply the guaranteed power level of the preamble transmission grouping (e.g., group “A”) instead of the guaranteed power level associated with the other group (e.g., of the SCG). It is contemplated that applying a specific treatment to a type of transmission (e.g., a higher priority to such transmissions) may be useful and/or desirable. In certain representative embodiments, the WTRU may determine that such transmissions (e.g., a preamble associated with the transmission group “A”) have a higher priority than other transmissions of another group in which the transmission may also qualify (e.g., the SCG, for example in case that a preamble is transmitted on resources of the SCG), for example, which may allow the WTRU to subtract the power allocated to the preamble from that otherwise available to that other group.

### 6.3 Representative Adaptive Power Control

The following adaptive power control may be described in the context of 5G wireless systems (e.g., NR), without limitation to its applicability to other systems. The following adaptive power control described below may be used in part, individually, in combination and/or in any order.

In some embodiments, the adaptive power control may be performed:

per a group of transmissions, e.g., transmissions associated with a CG, a BWP, a MAC instance, a type/set of physical channels, a radio access technology (e.g., LTE and/or NR), a transmission profile (e.g., a transmission time (e.g., TTI) duration, one or more numerologies, a beam set, etc.);

per a type of control channel that does the respective scheduling (e.g., CORESET);

per a type of transmission (e.g., initial HARQ transmission, HARQ retransmission, and/or the last transmission before reaching the maximum number of retransmissions for the HARQ process); and/or

any combinations of the above.

6.3.1 Representative Adaptive Power Allocation with Dynamic Reservation

In an embodiment, a WTRU may be configured with a power control mode. For example, the mode may correspond to PCM 4 above.

### 6.3.1.1 Representative Adjustment to a Guaranteed Power Level

In some embodiments, PCM 4 (or equivalent logic) may be aimed to realize an opportunistic use of the total WTRU's available power resources. In PCM 4, the WTRU may adjust one or more guaranteed power levels as a function of at least one of:

the rate of uplink transmissions (and/or the rate of power consumption) for a group of transmissions (e.g., using a window);

one or more power scaling events for the group. In certain embodiments, the power scaling may occur while (e.g., only while) the WTRU is not configured to use the maximum configured guaranteed power for the group (e.g., to react to an insufficient power level setting);

explicit control signaling received on a downlink control channel (e.g., a DCI). In certain embodiments, the signaling may be applicable (e.g., only applicable) on a specific control channel (e.g., CORESET) and/or for a specific group of transmissions. For example, the signaling may indicate (e.g., by an index to a configuration and/or to a value) at least one of the following:

a) a step unit increase or decrease of a guaranteed level;

b) an indication to move to an upper value, e.g., using an (index to an) absolute value or an indication, e.g., P_{GUARhigh_XeNB} as described below;

c) an indication to move to a lower value, e.g., using an (index to an) absolute value or an indication, e.g., P_{GUARlow_XeNB} as described below;

d) an indication for a specific configuration of the power control mode, e.g., according to the parameters below, for example, using an index to the configuration;

e) grant information as a reservation. In certain embodiments, the WTRU may receive sufficient scheduling information to determine a power level for one or more transmissions, but then may not be requested to perform the transmission. The WTRU may then use such grant information in the determination of the power allocation to perform a transmission-based reservation. In other embodiments, the reservation may last for one or multiple transmission occasions, which may be a configuration process of the WTRU and/or indicated in the received signaling. The reservation may be for a specific group of transmissions. For example, the reservation may expire when the WTRU receives a grant for the group of transmissions. The grant reservation may be useful, for example, to ensure that power corresponding to a possible transmission may be available for the group, if useful and/or necessary.

In an embodiment, the grant reservation may be considered in adjusting one or more guaranteed power levels as if the WTRU had been scheduled to perform a transmission. The grant reservation may be useful for the network, for example, to more accurately control the adjustments in the WTRU's power control implementation.

f) a priority adjustment. In certain embodiments, the WTRU may receive priority information, for example, with grant information. The WTRU may use the indication to update the priority of a group of transmissions.

Beam Management or Beam-Related Events

In certain embodiments, a WTRU may be configured to determine to adjust one or more guaranteed power levels (e.g., by setting a guaranteed power level to any level, including zero) as a function of at least one of the following:

(a) The WTRU may determine that the WTRU has no valid downlink (DL) timing reference for any uplink beam in a set of one or more uplink beams and/or BPL for a group of transmissions (e.g., per CG, transmission profiles, type of transmissions, etc.). In an embodiment, a DL beam used as a reference may be part of the set of one or more uplink beams and/or BPL for the group;

(b) The WTRU may determine that the WTRU has no valid downlink pathloss reference for any uplink beam in the set of one or more uplink beams and/or BPL for the group of transmissions. In some embodiments, a DL beam used as a reference may be part of the set of one or more uplink beams and/or BPL for the group;

(c) The WTRU may determine insufficient beam link quality (e.g., indicated by measurements) for the set of one or more uplink beams and/or BPL for the group of transmissions. In some embodiments, the WTRU may determine that the Layer 3 measurements (e.g., the averaged measurement for N best beams in the set) is less than a threshold value. The threshold value may be configured by signaling. In other embodiments, the WTRU may determine that the Layer 1 measurement is less than a threshold value. The threshold value may be configured by signaling. The Layer 1 measurements may be performed or obtained, e.g., using applicable CSI-RS for a beam (or set thereof, when a single measurement is performed for multiple beams using a CSI-RS resource) or cell-specific SS. In some embodiments, the Layer 1 measurements may be performed or obtained, e.g., using applicable CSI-RS for all beams of the set/BPL. Applicable CSI-RS may include CSI-RS on periodic resources (e.g., for pathloss estimation, timing alignment tracking, RSRP measurements), on semi-static configured resources (e.g., possibly for improvements to RSRP measurements), and/or on aperiodic scheduled resources (e.g., possibly to further improve RSRP measurements);

(d) The WTRU may determine that some or the whole of the uplink beams are unavailable for the set of one or more uplink beams and/or BPL for the group of transmissions, e.g., in a failure state;

(e) The WTRU may determine that beam recovery is ongoing for the set of one or more uplink beams and/or BPL for the group of transmissions; and

(f) The WTRU may determine that beam change (e.g., switch) and/or modification (e.g., reconfiguration) are ongoing for the set of one or more uplink beams and/or BPL for the group of transmissions, for example if such makes those beams unavailable for transmission.

In some embodiments, the WTRU may determine to adjust one or more guaranteed power levels (e.g., set to a non-zero, a default value, or an initial value) when the WTRU determines that any (or all) of the above conditions described in beam management or beam-related events (a)-(f) are no longer true. In some embodiments, the WTRU may determine that beam recovery has been successfully performed or completed for the set of one or more uplink beams and/or BPL for the group and may adjust a corresponding guaranteed power level to the initial (e.g., possibly configured) value for the group.

### 6.3.1.2 Representative Parameters Applicable to Dynamic Power Control Adjustments

In some embodiments, a WTRU may be configured with one or more parameters that control the WTRU's allocation of power for uplink transmissions. For example, the parameters may include at least one of:

a minimum guaranteed power (e.g., P_{GUARlow_XeNB}):

This value may be configured for a group of transmissions. In some embodiments, the group may correspond to a MCG, a SCG, or any other grouping of transmissions. This value may correspond to the minimum possible share or fraction of the total available WTRU transmission power (e.g., P_{CMAX}) that may be allowed for the group, e.g., when using PCM 4.

A guaranteed power value of 0 may be configured for a group of transmissions of low priority. For example, this may be for a group associated with a secondary group, e.g., a SCG. For example, this may be for a group that may not include control signaling, e.g., for data radio bearers (DRBs). For example, this may be for a group that may not include data from specific services and/or transmission profiles, e.g., for eMBB and/or for specific QoS scheduling strategies that are more for best-effort type of transmissions.

In some embodiments, the WTRU may determine after a certain period of (e.g., scheduling and/or transmission) inactivity for the group of transmissions that the guaranteed power may be set to the minimum value (e.g., 0). In exemplary embodiments, when the WTRU is configured to perform a transmission for the group, it may then be possible that the first transmission following an inactive period may lead to insufficient (possibly 0) transmission power, in which case the power control function may be configured to ensure that the level of guaranteed power can quickly increase to a sufficient level, e.g., upper bounded by a maximum guaranteed power, as set forth below.

a maximum guaranteed power (e.g., P_{GUARhigh_XeNB}):

This value may be configured for a group of transmissions. In some embodiments, the group may correspond to a MCG, a SCG, or any other grouping of transmissions. This value may correspond to the maximum possible share or fraction of the total available WTRU transmission power (e.g., P_{CMAX}) that may be allowed for the group, e.g., when using PCM 4. A value of 100% (or infinity) may be configured for a group of transmissions of high priority. For example, this may be for a group associated with a primary group, e.g., a MCG. For example, this may be for a group that may include control signaling, e.g., for SRBs. For example, this may be for a group that may include data from specific services and/or transmission profiles, e.g., for URLLC and/or for specific QoS scheduling strategies.

In certain embodiments, a WTRU may determine after a certain period of (e.g., scheduling and/or transmission) activity, for example with a specific intensity, for the group of transmissions that the guaranteed power may be increased gradually towards the maximum value (e.g., 100%). In some embodiments, levels associated with other group(s) of the WTRU's configuration may decrease sufficiently to enable this increase, e.g., when the group is predominantly active in transmissions. In another embodiment, when the WTRU determines to increase the guaranteed level for one or more other groups (e.g., when scheduling may resume for the other groups), the WTRU may decrease the guaranteed level accordingly.

### 6.3.1.3 Representative Overview of WTRU Logic for Dynamic Power Level Adjustments

In some embodiments, the WTRU may perform adjustment of the guaranteed power level(s). In certain embodiments, the adjustments may be specific to the power control parameters associated with a specific group of transmissions. For example, within a group of transmissions, further allocation of power between possibly overlapping transmissions may be performed according to the operations of PCM 1 (e.g., carrier aggregation in a MCG where the operation is relatively synchronous in terms of scheduling information and/or start of the overlapping transmissions) and/or PCM 2/PCM 3 (e.g., other cases such as dual connectivity between LTE and NR, NR and NR, Carrier Aggregation with TTIs of different durations, or the like).

In another embodiment, the rate of the adjustment may be a function of: a window size (e.g., a sampling period for events), the inter-packet/burst, the maximum acceptable latency, and/or control signaling, e.g., explicit adjustments. With regard to maximum acceptable latency, the rate may be a function of the RTT for a transmission associated with a HARQ process handling a transmission of the group. In this manner, the WTRU may have means to assign the necessary transmit power for the transmission before reaching the maximum number of HARQ transmissions for the HARQ process.

For example, the WTRU may determine to perform an adjustment when it receives HARQ feedback for a HARQ process associated with a group of transmissions. For example, the UE may increase the power level upon reception of a NACK or decrease it upon reception of an ACK.

Such acceptable maximum latency could be established by a timer, which may be started upon the first transmission for a given HARQ process, and whereby the WTRU may increase the power level for the associated group when it expires and the HARQ process has not completed (e.g, the WTRU did not receive an ACK for any transmission of the HARQ process)”

### 6.3.1.4 Representative Events Considered for Adjusting a Guaranteed Power Level

In some embodiments, a WTRU may consider at least one of the following events in determining whether and what adjustments to make:

reception of uplink scheduling information;

In some embodiments, a WTRU may receive a DCI indicating resource allocation information for an uplink transmission for a group of transmissions. The WTRU may consider these events in determining an increase to a current power level for the group of transmissions. In certain embodiments, the WTRU may consider the events when the current guaranteed power level for the group of transmission is below a maximum threshold, e.g., P_{GUARhigh_XeNB}.

allocation of power to an uplink transmission;

In some embodiments, a WTRU may allocate uplink transmission power to one or more transmissions of a group of transmissions. This may be irrespective of whether or not downlink scheduling information has been received, e.g., for a preamble sent on PRACH resources, for a grantless transmission, and/or for a semi-persistent or configured grant. In certain embodiments, the WTRU may consider such an event in determining an increase to the current level for the group of transmissions. In another embodiment, the WTRU may consider such an event only if the current guaranteed power level for the group of transmission is below a maximum threshold, e.g., P_{GUARhigh_XeNB}.

adjustment(s) in another group of transmission (increase/decrease);

In some embodiments, a WTRU may determine that a guaranteed power level for a group of transmission may be changed. In certain embodiments, when an event occurs in connection with a first group of transmissions with a higher priority that results in an increase of the power level (e.g., for a URLLC transmission) for that group of transmissions and there is no available remaining power (for an increase event), the WTRU may decrease the power level of a second, lower priority group of transmissions that is not currently at the minimum level for the second group.

In some embodiments, the WTRU may determine to decrease the guaranteed power level of a group of transmissions (a decrease event). In such a case, the amount of power released may be reassigned to another group of transmissions.

adjustment(s) to the amount of remaining power;

In some embodiments, a WTRU may determine to decrease the guaranteed power level of a group of transmissions. In this case, the amount of remaining power may increase accordingly. Such non-zero amount of remaining power may be made available to other groups of transmissions for which the current guaranteed level is currently below the maximum possible guaranteed level for the group, e.g., P_{GUARhigh} (an increase event). The remaining power may be allocated to the guaranteed levels of such groups, for example, according to a priority ordering (e.g., configured) of the different other groups. In one embodiment, the WTRU may distribute some or all of the remaining power to a specific group of transmissions only if the WTRU determines that a specific event occurred for that group of transmissions. For example, such event may comprise any event that triggers an increase of the guaranteed power level for the group. Such event may be associated with the group's power level management. For example, such power level management may use a window-based operation, whereby at least one increase event has occurred during a given period of time for which the WTRU has not yet increased the power level of the group

received signaling indicating changes;

In some embodiments, a WTRU may receive a power control indication that modifies one or more guarantee levels of one or more groups of transmissions. This may be applied based on respective priorities between the groups, e.g., if there is an insufficient amount of remaining power. This may correspond to either an increase event or a decrease event for the group(s) of transmissions according to the received signaling indicating changes.

power scaling applied for a group of transmissions based on a certain condition;

In some embodiments, the condition may include that a WTRU is not using all available power, e.g., the guaranteed power level may be higher than necessary for other groups of transmissions or the other groups may be inactive in transmissions. The other groups may include, for example, groups of a priority no higher (or lesser) than that of the group of transmissions for which power scaling has occurred. In another embodiment, the condition may include that the WTRU has at least one other group of a priority no higher (or lesser) than that of the group of transmissions for which power scaling has occurred with a guaranteed level above the minimum level for the one or more groups. The WTRU may consider the event in the determination of an increase to the current level for a group of transmissions.

Power scaling for all groups of transmissions active with transmissions;

In some embodiments, a WTRU may determine that it is power-limited, e.g., even if sharing all available power would be ideal. The WTRU may then determine to back off different groups of transmissions to the minimum level (e.g., to an even lower level, e.g., zero). In certain embodiments, the adjustments may be performed starting from the group of transmissions with lowest priority and in increasing order of priority. In other embodiments, all available power may be made available to a specific (e.g., configured) group of transmissions, e.g., a primary group of transmission (e.g., the MCG and/or the PCell of the MCG).

Radio Link Failure/Radio Link Monitor (RLF/RLM)-related events;

In some embodiments, a WTRU may determine that quality of the physical resources and/or channels of a specific group of transmissions may be below a certain threshold. For example, an RLF event for a group of transmissions that may carry control plane signaling (e.g., only Signaling Radio Bearer (SRB)0, SRB1 and/or SRB2, e.g., for the MeNB) which may lead to a re-establishment of the control plane using the principles of single connectivity. The event may occur for other group(s) of transmissions. In this case, the WTRU may perform adjustments of the guaranteed levels such that the guaranteed power level of the group(s) may be decreased (e.g., down to 0). The difference may be re-assigned to another group of transmissions, e.g., to skew in favor of a group of transmissions with higher priority.

beam blockage and/or beam management operations;

In some embodiments, a WTRU may determine that the quality of the physical resources and/or channels of a specific group of transmissions may be below a certain threshold due to beamforming problems (e.g., blockage, loss of synchronization, etc.). In this case, the WTRU may perform similar actions as described for RLF/RLM events for the group of transmissions.

Other impairments;

In some embodiments, a WTRU may determine that an error case occurred in relation to the physical resources, channels, procedures, or similar matters associated with a specific group of transmissions. For example, this may include a failure to successfully complete a random access procedure for the group. For example, this may include a failure to successfully complete a scheduling request procedure. For example, this may include loss of uplink timing alignment, e.g., expiration of a timing alignment timer associated with the group of transmissions. For example, this may include loss (or failure to track/detect) a timing reference for the group of transmissions. For example, this may include loss (or failure to track/detect) a path loss reference for the group of transmissions. For example, this may include loss (or failure to track/detect) a reference signal, e.g., for the purpose of beam management for the group of transmissions. In such cases, the WTRU may perform similar actions as described for RLF/RLM event for the group of transmissions.

accumulated consumed power;

In some embodiments, a WTRU may determine that a certain, threshold amount of power has been consumed for a specific group of transmission. In certain embodiments, when reaching such (e.g., configured) a threshold, the WTRU may determine that it may decrease the current guaranteed power level for the group of transmissions (e.g., for a certain period).

accumulated prioritized power;

In some embodiments, a WTRU may determine that it has not consumed a certain amount of power during a specific amount of time. This may be based on a configuration of a prioritized power rate for the accumulation of a prioritized amount and a bucket duration. In some embodiments, the WTRU may determine that it may increase a level of guaranteed power for the group of transmissions when the amount of prioritized power reaches a certain amount (e.g., for a certain period).

In some embodiments, this may be applicable in combination with the event for the accumulated transmission power, for example, where the increase in guaranteed power level may be according to the prioritized power rate, e.g., up to its accumulated power level amount (e.g., a credit-based mechanism) and a decrease in guaranteed power level may be according to the accumulated consumed power (e.g., a debit mechanism) for a given period. For example, this may be a mechanism whereby a “bucket” is filling using a specific rate over time and empties as power is being used for the group of transmissions. In another embodiment, such events may be defined per group of transmissions.

### 6.3.1.5 Representative Maintenance of a Guaranteed Power Level

### 6.3.1.5.1 Representative Period-Based Updates

In some embodiments, a WTRU may perform one adjustment per a period of time. The period of time may be included in a configuration of the WTRU. The period of time may be configured for each group of transmissions. The WTRU may perform one such adjustment per group of transmissions. The period of time (or window as further described below) may affect the latency of the adjustment for a group of transmissions, for example, the responsiveness of the algorithm for the group of transmissions. For example, the algorithm controlling the rate adjustment may be more responsive with a short window in which the WTRU considers any number of events within that window as an indication to perform a single adjustment. Conversely, a long window will lead to a less responsible adjustment rate. In other embodiments, the period of time may be counted in integer multiples of the minimum TTI duration for the group of transmissions. In other embodiments, the period of time may correspond to a default time unit, for example, a subframe duration (e.g., 1 ms).

### 6.3.1.5.2 Representative Window-Based Operation

In some embodiments, a WTRU may perform adjustments using a window-based operation. In certain embodiments, a WTRU may perform at most one adjustment per window of time for a given type of event (e.g., increase or decrease). The WTRU may perform an adjustment immediately for some events, e.g., events related to a failure case and/or an impairment-related event.

### 6.3.1.5.3 Representative Additive Increase—by a Factor

In some embodiments, a WTRU may perform the one adjustment per window as an increase of a guaranteed power level by adding a fixed, possibly configured, amount. For example, the value may be equal to 1/10^{th} of P_{CMAX}. The updated guaranteed power level following an increase may be upper bounded by a value (e.g., P_{GUARhigh_XeNB}) as described earlier.

### 6.3.1.5.4 Representative Multiplicative Increase—by a Multiple of a Factor

In some embodiments, a WTRU may adjust to increase a guaranteed power level by adding an integer multiple of a fixed, e.g., configured, amount. For example, the WTRU may double its current guaranteed power level. In another example, the adjustment can be performed at moments that are discrete in time (e.g. only when power actually needs to be assigned for the group of transmissions) and not necessarily at every time the WTRU determines that an event has occurred. In fact, this may be applied in any of the adjustment schemes discussed herein section 6.3.1.5. The increase may be upper bounded by a value (e.g., P_{GUARhigh_XeNB}). The updated guaranteed power level following an increase may be upper bounded by a value (e.g., P_{GUARhigh_XeNB}) as described earlier.

In other embodiments, the WTRU may adjust to increase a guaranteed power level by doubling the current guaranteed power level. In certain embodiments, doubling the guaranteed power level may be performed upon a specific event (e.g., an initial transmission), e.g., for a given window and/or period, following a certain period of inactivity, when the current level for the group of transmission may be equal to P_{GUARlow_XeNB}, and/or when the current level for the group of transmissions is zero. The updated guaranteed power level following an increase may be upper bounded by a value (e.g., P_{GUARhigh_XeNB}) as described earlier.

### 6.3.1.5.5 Representative Sequential Increase—Moving Through a Sequence

In some embodiments, a WTRU may adjust by moving forward sequentially through a list of values, e.g., 20, 30, 40, 50, for example where P_{GUARlow_XeNB}=20 and P_{GuARhigh_XeNB}=50.

### 6.3.1.5.6 Representative Subtractive Decrease—by a Factor

In some embodiments, a WTRU may adjust to decrease a guaranteed power level by subtracting a fixed, e.g., configured, amount. For example, the value may be equal to 1/10th of PCMAX. The updated guaranteed power level following a decrease may be lower bounded by a value (e.g., P_{GUARlow_XeNB}) as described earlier.

### 6.3.1.5.7 Representative Multiplicative Decrease—by a Multiple of a Factor

In some embodiments, a WTRU may adjust to decrease a guaranteed power level by subtracting an integer multiple of a fixed, e.g., configured, amount. In another example, the adjustment can be performed at moments that are discrete in time (e.g. only when power actually needs to be assigned for the group of transmissions) and not necessarily at every time the WTRU determines that an event has occurred. The decrease may be lower bounded by a value, e.g., P_{GUARlow_XeNB}. The updated guaranteed power level following a decrease may be lower bounded by a value (e.g., P_{GUARlow_XeNB}) as described earlier.

### 6.3.1.5.8 Representative Sequential Secrease—Moving Through a Sequence

In some embodiments, a WTRU may perform the adjustment by moving backwards sequentially through a list of values, e.g., 20, 30, 40, 50, for example where P_{GUARlow_XeNB}=20 and P_{GUARhigh_XeNB}=50.

### 6.3.1.5.9 Representative Increase/Decrease of a Power Level

In some embodiments, increasing and decreasing a guaranteed power level may be specific to a group of transmissions. This may be useful to control the rate of adjustment per group of transmissions, e.g., the reactiveness of the algorithm for the group of transmissions.

### 6.3.1.6 Representative Additional Conditions for Adjusting Guaranteed Power Levels

For any event for which the WTRU determines that an adjustment may be performed, additional conditions may be considered including at least one of the following:

a level of the remaining power, for example whether or not the amount of remaining power is non-zero. In some embodiments, the WTRU may perform the determination after processing of any events that may lead to a decrease of the guaranteed power level for other groups of transmissions, if any; and/or

a relative priority between different group of transmissions, for example whether or not the current group has a higher priority than other groups for which an adjustment may also be applicable, if any.

### 6.3.1.6.1 Representative Configured Uplink Grants

Configured grants (i.e., transmissions scheduled by configured grants) may be part of a special group or may receive special handling within a group. Specifically, configured grants may have limitations on the adjustments they can incur e.g. it may not be possible to take from them and/or lower their guaranteed power level. Also, they may have a specific range to move within that is different from other transmissions. In some embodiments, they may be treated like any other grant. In other embodiments, they might be excluded entirely, i.e., no adaptation supported at all (power level or range always remains constant). In some embodiments, the priority of a transmission scheduled using a configured grant may differ from the priority of other transmissions, e.g., they may have a higher priority than other transmissions when assigning remaining power.

In some embodiments, a WTRU may consider that a power level that may be used and/or necessary for a configured uplink grant may be considered as reserved for the group of transmissions. In other embodiments, the WTRU may consider the grant and allocate power to the transmission independently of the guaranteed power level for the group to which the configured grant belongs. This may result in power being allocated within a range (e.g., not exceeding P_{GUARhigh_XeNB} for the group) and for a period (e.g., TTIs, mini-slots, slots, and/or subframes) of the configured transmission. The period may further include any period during which the transmission overlaps with other transmission opportunities (e.g., TTIs) before and after the transmission time for the configured uplink grant. In an embodiment, a configured uplink transmission may be further considered as an event similar to dynamic scheduling, for example, to enable some power level increase (if applicable) for potential HARQ retransmissions. In another embodiment, a configured uplink transmission may be excluded from the considered events for the guaranteed power adjustments.

### 6.3.1.6.2 Representative Grantless Transmissions

In some embodiments, a WTRU may perform a grantless transmission, e.g., a transmission where the WTRU autonomously determines timing of the transmission. In this case, the WTRU may perform a behavior similar to that for a configured grant.

### 6.3.1.6.3 Representative Channel-Specific (e.g., PRACH)

In some embodiments, a WTRU may perform a transmission on a specific physical channel set of resources and/or for a specific procedure. For example, the WTRU may perform the transmission of a preamble on the PRACH. The transmission may be given a high priority. In other embodiments, the WTRU may assign as much transmission power as possible and/or required independently of the guaranteed levels. In some embodiments, a transmission on the PRACH may be considered as an event. The transmission on the PRACH may be performed for a transmission group. In other embodiments, the transmission on the PRACH may be performed when the preamble is transmitted for the purpose of acquiring uplink transmission resources, e.g., triggered by reception of a DCI (e.g., Physical Downlink Control Channel (PDCCH) order for downlink data arrival) or by a scheduling request (e.g., RA-SR), e.g., not for requesting system information. In some embodiments, the priority may be per a group of transmissions and/or per a set of PRACH resources (if applicable).

In other embodiments, the WTRU may use similar procedures/operations as described above to autonomously adjust the priorities associated with a group of transmissions. Priorities may be adjusted within a range of values, for example this range may be specific to a group of transmissions. For example, this may be useful if PCM 4 is set/defined as an extension of PCM 1 principles/operations, e.g., in a synchronous deployment.

### 6.3.2 Representative Adaptive Power Allocation by Scheduling/Transmission Activity

In some embodiments, a WTRU may be configured with a power control mode. For example, the mode may correspond to a variant of the PCM 4 mode described above. This variant may be based on inactivity timers.

In certain embodiments, the WTRU may start an inactivity timer when it determines that a first transmission may be performed. The inactivity timer may be configured on the WTRU. The inactivity timer may be applied per group of transmissions. The inactivity timer may be started from the time the WTRU receives the DCI or at the time of the corresponding transmission. In another embodiment, if not running, the inactivity timer may be started for a first transmission of a group of transmissions. On the other hand, if already running, the WTRU may restart the inactivity timer for a first transmission of a group of transmissions.

In some embodiments, the WTRU may determine to use a first specific guaranteed power level while the timer is running. For example, this may correspond to P_{GUARhigh_XeNB} or similar. In other embodiments, the WTRU may determine the guaranteed power level using a second specific guaranteed power level. For example, this may correspond to P_{GUARlow_XeNB} or similar.

In other embodiments, the WTRU may use events similar to those described herein to determine when to start or re-start the inactivity timer, e.g., such as events that would lead to an increase of the guaranteed power level. For example, the WTRU may stop the inactivity timer for events that may lead to a decrease of the guaranteed power level.

### 6.3.3 Representative Power Allocation by Time-Dependency

### 6.3.3.1 Representative PCM 2: “First in Time” Becomes “First to DCI”

In some embodiments, a WTRU may be configured with a power control mode similar to PCM 2, for example, where the remaining power may be assigned to a group of transmissions as a function of the time of reception of the downlink control information (DCI), where the remaining power is first made available to a group of transmissions that was scheduled (e.g., based on the starting symbol of the first successfully decoded DCI) instead of a time-based operation in which the first to start a transmission in time is provide the allocation.

### 6.3.3.2 Representative Linkage to Previous Transmission

In some embodiments, a WTRU may perform an autonomous determination of power sharing/power reservation levels as a function of any of:

a relationship between power allocation of initial transmission for a HARQ process and its retransmissions (e.g., at least the same guaranteed level may be used, or priority, for a retransmission as used for the initial transmission). In an embodiment, this may be based on the New Data Indication (NDI) determined from the scheduling information.

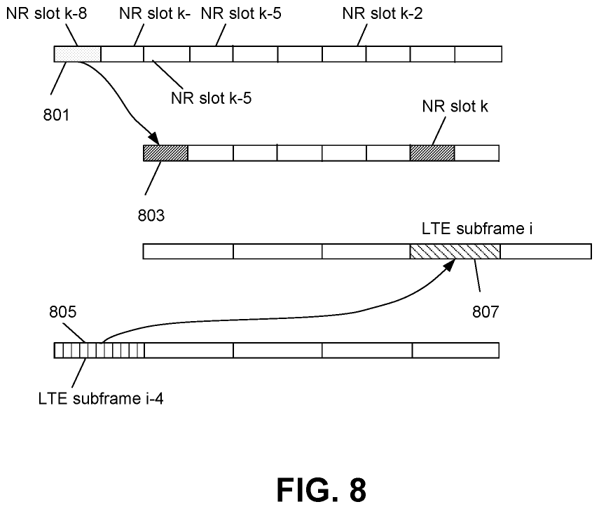

a relationship with a previous transmission. In some embodiments, in LTE and NR interworking (dual connectivity with an LTE eNB serving as the MeNB) as illustrated in FIG. 8, a NR slot may be considered as lasting 0.5 ms with a DCI-to-grant delay of 2 slots for NR. When it attempts to minimize changes to the LTE part of the modem, no look-ahead may be allowed for LTE. FIG. 8 is a timing diagram illustrating a representative transmission in dual connectivity (e.g., based on LTE and NR). FIG. 8 illustrates a power allocation by time-dependency embodiment, e.g., a timing relationship between reception of an uplink grant 801 in NR (e.g. at NR slot k-8) and its corresponding transmission 803. Also shown is a timing relationship between the reception of an uplink grant in LTE 805 (e.g., in LTE subframe i-4) and its corresponding transmission 807 in LTE subframe i. FIG. 8 illustrates two overlapping transmissions, one in NR slot k and one in LTE subframe i. To determine the power of LTE subframe i, the WTRU may use the knowledge of NR grants up to NR slot k-7. The actual power requirement of NR in slot k may be known after NR slot k-2. In this case, there may be the following options:

Option 1 is to allow LTE to use all of the “remaining power” during the time period corresponding to LTE subframe i. This effectively may mean that LTE always has priority over NR. In some embodiments, this may be good in an EN-DC scenario with an LTE master (i.e., Dual Connectivity with eNBs of different radio access technologies, in this case, LTE being the MeNB and NR being the SeNB). If NR is used for URLLC, a large guaranteed power may need to be configured.

Option 2, to reduce unfairness, is to assume that the power requirement of NR in NR slot k will be the same as in NR slot k-6 (or k-5). Power may be “wasted” if NR power requirement decreases between slot k-5 and slot k.

In some embodiments, the power allocation of LTE in subframe i could take into account the actual transmission in NR slot k. In an embodiment, a decision on whether to scale down some LTE transmissions may be done at the same time as NR. This may be feasible, although it may be preferable to avoid mixing the different timelines.

### 6.3.3.3 Representative Power Allocation and Transmission Formats

In a representative embodiment, the UE may prioritize transmissions based on the transmission format. For example, the UE may prioritize a first PUCCH format as a higher priority than a second PUCCH format, for example, when allocating transmission power to the first and second PUCCHs. In another representative embodiment, the WTRU may prioritize transmissions based on a type of transmissions and their respective transmission formats. For example, the UE may prioritize an uplink control channel, e.g., of the PUCCH type using a first PUCCH format, as a higher priority than an uplink data channel, e.g., of a PUSCH type without any uplink control information. On the other hand, the UE may prioritize a first transmission of an uplink data channel, e.g., of the PUSCH type with uplink control information, as a higher priority than a second transmission type of an uplink control channel, e.g., of a PUCCH type using a second PUCCH format.

In some representative embodiments, the WTRU may select a transmission format for a given type of transmission (e.g., a PUCCH transmission) as a function of the power allocation. This is because the number of bits in the PUCCH is a factor in the determination of the required transmit power of the PUCCH transmission. Hence, to reduce the amount of power needed for the PUCCH, the WTRU can choose a PUCCH format with fewer bits. Code Block Group (CBG)-based feedback requires more bits, and thus more power, and thus it could be selected when power available to the concerned group of transmissions is sufficient. For example, the WTRU may select a PUCCH format with a specific number of uplink control information bits such as a number of bits sufficient for reporting HARQ feedback per code block group (e.g., CBG-based feedback). As another example, the WTRU may select the PUCCH format as a function of the impact of the format on the allocation of power to a transmission. In such cases, the WTRU may select a PUCCH format with the necessary number of uplink control information (UCI) bits, such as a format that supports CBG-based HARQ feedback. For example, the WTRU may select a format with the necessary number of UCI bits when it determines that allocation of power to such transmission would not lead to scaling of the transmission power for the transmission of the feedback itself and/or for another transmission. Otherwise, the WTRU may select a PUCCH format that supports fewer UCI bits such as a format that supports HARQ feedback per transport block (TB) (e.g., with fewer number of bits than for CBG-based feedback).

### 6.4 Representative Exemplary Outcomes of the Above-Principles for Adjustments of Guaranteed Levels

In some embodiments, a WTRU may determine that a group of transmission has been using less than the guaranteed power for the group over a certain period of time, and may gradually decrease the guaranteed level, e.g., down to a certain minimum level (which may be a configuration for the WTRU).

Similarly, the WTRU may determine that a group of transmission has been using (e.g., from an assignment of the remaining power) more than the guaranteed power for the group over a certain period of time, and may gradually increase the guaranteed level, e.g., possibly up to a certain maximum level (which may be a configuration aspect for the WTRU).

In some embodiments, the WTRU may perform these determinations if at least one scaling event has occurred for at least one group of transmissions. It may be possible that scaling is not applied to every group of transmissions during the same period of time (i.e., some groups may not be scaled at this time, while other groups are). In other embodiments, the WTRU may receive downlink control signaling that indicates either by stepwise adjustments or by absolute values (e.g., based on an index to a value received in a DCI) to further adjust the power levels. The portion of the available power that remains unassigned following the dynamic adjustments may be assigned to the remaining power.

In some embodiments, the WTRU may determine that a scaling event has occurred for one group of transmissions. In this case, the WTRU may assign the portion of the remaining power to the group of transmissions. In other embodiments, the WTRU may perform the assignment for a certain amount of time, e.g., for a time that corresponds to the completion of the transmissions for which scaling first occurred. In another embodiment, the WTRU may perform the assignment after a specific amount of time, e.g., after a time that corresponds to the earliest possible scheduling opportunity for the group of transmissions.

In some embodiments, the WTRU may determine that a scaling event for a first group of transmissions leads to the guaranteed levels of other groups of transmissions reverting to a specific level (e.g., a backoff). In an embodiment, this may be useful such that there may be more remaining power to contend for and/or to allow for the first group of transmissions for subsequent transmissions such that it may increase its guaranteed level.

### 6.4.1 Representative Outcomes of the Above Principles for Adjustments of Guaranteed Levels

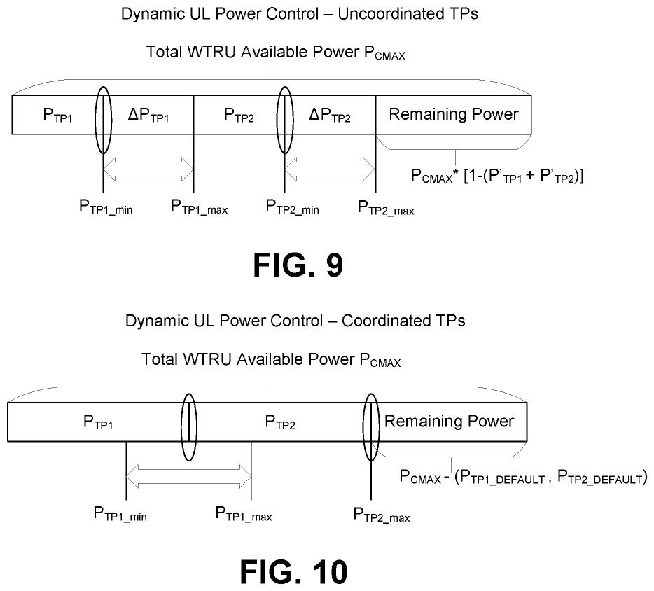

FIG. 9 is a diagram illustrating a representative dynamic uplink power control procedure having varying remaining power. The representative dynamic uplink power control procedure illustrated in FIG. 9 may be applicable, for example, in the case of uncoordinated scheduling for transmissions associated with different TPs (e.g., for uncoordinated TPs). Referring to FIG. 9, the power (e.g., each power) reserved for each group of transmissions shown is denoted as P_{TP1} and P_{TP2}, respectively, wherein each transmission power, P_{TP1} and P_{TP2}, is expressed as a fraction of P_{CMAX}. The total WTRU available power is denoted as P_{CMAX}. P_{TP1} and P_{TP2} may vary within a range, for example, by ΔP_{TP1} and ΔP_{TP2}, respectively. ΔP_{TP1} may be a power difference between a maximum power for TP1 and a minimum power for TP1. ΔP_{TP2} may be a power difference between a maximum power for TP2 and a minimum power for TP2. Such variation may be performed according to any of the procedures/operations described herein, for example, based on reception of a DCI and/or its contents, scheduling activity, radio link quality, beam link quality, additional power increase operations/procedures/methods, and/or multiplicative decrease operations/procedures/methods, or the like. In other representative embodiments, an amount of remaining power may vary. For example, one or more TPs may trade power levels (e.g., up to their respective ΔP_{TP}) to or from the remaining power amount while adjusting (e.g., increasing or decreasing) their power levels within their respective guaranteed ranges. The remaining power may then be decreased, for example, in favor of the most active TP. For example, the remaining power may be calculated as follows:

The remaining power=P_{CMAX}*[1−(P′_{TP1}+P′_{TP2})], wherein P′_{TP1} is an actual transmission power for TP1 (expressed as a fraction of P_{CMAX}) and P′_{TP2} (also expressed as a fraction of P_{CMAX}) is an actual transmission power for TP2.

### 6.4.2 Representative Outcomes of the Above Principles for Adjustments of Guaranteed Levels

FIG. 10 is a diagram illustrating a representative dynamic uplink power control procedure having a constant remaining power. The representative dynamic uplink power control procedure illustrated in FIG. 10 may be applicable, for example, in the case of coordinated scheduling for transmissions associated with different TPs (e.g., for coordinated TPs). Referring to FIG. 10, the power (e.g., each power) reserved for each group of transmissions is denoted as P_{TP1} and P_{TP2}, respectively. The total WTRU available power is denoted as P_{CMAX}. P_{TP1} may vary within a range between a maximum power boundary for TP1 and a minimum power boundary for TP1. P_{TP2} may vary within a range between a maximum power boundary for TP2 and a minimum power boundary for TP2 (not shown in FIG. 10). The variation within the range may be performed according to any of the operation/procedures/methods described herein, for example based on reception of a DCI and/or its contents, scheduling activity, radio link quality, beam link quality, additional power increase operation/procedures/methods, and/or multiplicative decrease operation/procedures/methods, or the like. In other representative embodiments, an amount of remaining power may be fixed and/or semi-fixed. For example, a plurality of TPs may trade power levels (and/or may trade incremental power levels between each other and/or among one another while possibly adjusting (e.g., increasing or decreasing) their power levels within their respective allowed guaranteed power level range). The remaining power may then remain constant. In such case, a non-zero amount of remaining power may ensure quick reactiveness for the allocation of power to the higher priority group of transmissions. For example, the remaining power may be calculated as follows:

The remaining power=P_{CMAX}−(P_{TP1_DEFAULT}+P_{TP2_DEFAULT}), wherein P_{TP1_DEFAULT} is an initial minimum guaranteed power for TP1 and P_{TP2_DEFAULT} is an initial minimum guaranteed power for TP2, and wherein each transmission power is represented as a fraction of P_{CMAX}.

Although only two TPs are shown, the procedure and remaining power may be used with any number of TPs, for example, by modifying the formula for remaining power to include an appropriate number of adjustment (e.g., reductions) for the number of coordinated TPs.

### 6.4.3 Representative Outcomes of the Above Principles for Adjustments of Guaranteed Levels

In some representative embodiments, the WTRU may be configured with a PCM characterized by: (1) a grouping of transmissions based on, e.g., a Transmission Profile (a TP) including any of: BWP, TTI, and/or RTT, among others; (2) an initial minimum guaranteed power P_{TP_DEFAULT} (e.g., configured by the RRC) for the configured (e.g., each configured) TPᵢ; (3) a range of power levels (P_{TP_min}, and/or P_{TP_max}) for the minimum guaranteed power per TP, or for one TP (e.g., only for one TP) (e.g., for P_{TP1} and/or P_{TP2} in FIG. 10); and/or (4) P_{TP_min}≤P_{TP_DEFAULT}≤P_{TP_max}, among others.

In some representative embodiments, the WTRU may receive downlink control signaling (e.g., DCI and/or, one or more MAC CEs) that may indicate the guaranteed power level for TPₓ (P_{TPx}). The WTRU may adjust the guaranteed power levels P′_{TPx} according to any of the following: (1) P_{TPx_min}≤P′_{TPx}≤P_{TPx_max}; (2) for constant remaining power as illustrated in FIG. 10, for example, the WTRU may increase or decrease P′_{TPx} by assigning guaranteed power to another TP or by taking guaranteed power from the other TP; and/or (3) for variable remaining power as illustrated in FIG. 9, the WTRU may increase or decrease P′_{TPx} by assigning guaranteed power to the remaining power or by taking guaranteed power from the remaining power.

In some representative embodiments, the WTRU may allocate a power to transmissions of different TP groups, for example, such that: (1) the sum of all transmission power of a group becomes P′_{TP}; and/or (2) the sum of all P′_{TP} becomes less than or equal to P_{CMAX} (e.g., at all time).

In other representative embodiments, the WTRU may adjust (e.g., autonomously adjust) the guaranteed power levels P′_{TP} within the range of power levels [P_{TP_min}, P_{TP_max}] as a function of the scheduling activity. For example, the WTRU may increase P′_{TP} when the WTRU determines a higher DCI rate for a certain TP, or decrease P′_{TP}, otherwise.

### 7 Conclusion

The contents of the following are each incorporated by reference herein: [1] 3GPP TS 36.101, v14.3.0: “Evolved Universal Terrestrial Radio Access (E-UTRA); User Equipment (UE) radio transmission and reception”; [2] 3GPP TS 36.321, v14.2.1: “Evolved Universal Terrestrial Radio Access (E-UTRA); Medium Access Control (MAC) protocol specification”; and [3] 3GPP TS 36.213, v14.2.0: “Evolved Universal Terrestrial Radio Access (E-UTRA); Physical layer procedure.”

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A method of power allocation between a plurality of transmissions by a wireless transmit/receive unit (WTRU), the method comprising:
obtaining a maximum transmit power level assigned for the WTRU;
establishing a first group and a second group of transmissions for uplink transmission by the WTRU;
determining a first initial guaranteed power level for the first group of transmissions and a second initial guaranteed power level for the second group of transmissions;
adjusting at least one of the first initial guaranteed power level and the second initial guaranteed power level based on one or more previous activities of the WTRU and the obtained maximum transmit power level assigned for the WTRU; and
transmitting the first group of transmissions at least at the first adjusted guaranteed power level and the second group of transmissions at least at the second adjusted guaranteed power level.

2. The method of claim 1 wherein:
each of the first group of transmissions and the second group of transmissions comprises one or more transmissions having a common transmission characteristic.

3. The method of claim 2 wherein the common transmission characteristic is at least one of: a bandwidth part (BWP), a transmission duration, a transmission time interval (TTI), a round-trip time (RTT), a set of physical transmission resources, a numerology, a Modulation and Coding Scheme (MCS) table, a Radio Network Temporary Identifier (RNTI), and a control resource set (CORESET).

4. The method of claim 1 wherein the adjusting comprises adjusting at least one of the first initial guaranteed power level and the second initial guaranteed power level based on at least one of a previous scheduling activity and one or more previous transmissions.

5. The method of claim 1 wherein the adjusting is restricted such that the first adjusted guaranteed power and the second adjusted guaranteed power each remain within a range.

6. The method of claim 1 wherein the determining a first initial guaranteed power level and second initial guaranteed power level comprises receiving the first initial guaranteed power level and second initial guaranteed power level in downlink control signaling.

7. The method of claim 6 wherein the downlink control signaling comprises at least one of downlink control information (DCI) and a media access control (MAC) control element (CE).

8. The method of claim 1 wherein the adjusting comprises adjusting the first and second initial guaranteed power levels such that a sum of the first and second adjusted guaranteed power levels remains constant, whereby a remaining power level between the sum of the first and second adjusted guaranteed power levels and the maximum transmit power level assigned for the WTRU remains constant.

9. The method of claim 1 the adjusting comprises adjusting the first and second initial guaranteed power levels such that a remaining power between the sum of the first and second adjusted guaranteed power levels and the maximum transmit power level assigned for the WTRU is variable.

10. The method of claim 1 wherein the adjusting the first guaranteed power level comprises adjusting the first guaranteed power level as a function of any one or more of: (1) a power level previously used for transmissions for the first group of transmissions and/or (2) a quantity of previously successfully decoded downlink control information (DCI) for a set of control resources for the first group of the transmissions.

11. The method of claim 1 wherein the adjusting of the first and second initial guaranteed power levels comprises the WTRU autonomously adjusting the first and second initial guaranteed power levels based on any one or more of: scheduling activity and reception of a DCI.

12. The method of claim 1 wherein the sum of all transmission power for transmissions in the first group of transmissions is equal to the first adjusted guaranteed power level and the sum of all transmission power for transmissions in the second group of transmissions is equal to the second adjusted guaranteed power level.

13. The method of claim 1 wherein the sum of the first and second adjusted guaranteed power levels is less than or equal to the maximum transmit power level assigned for the WTRU.

14. A Wireless Transmit Receive Unit (WTRU) adapted to allocate transmit power between a plurality of transmissions comprising:
a transmitter;
a receiver; and
a processor coupled to the transmitter and the receiver, the processor configured to;
obtain a maximum transmit power level assigned for the WTRU;
establish a first group and a second group of transmissions for uplink transmission by the WTRU;
determine a first initial guaranteed power level for the first group of transmissions and a second initial guaranteed power level for the second group of transmissions;
adjust at least one of the first initial guaranteed power level and the second initial guaranteed power level based on one or more previous activities of the WTRU and the obtained maximum transmit power level assigned for the WTRU; and
control the transmitter to transmit the first group of transmissions at least at the first adjusted guaranteed power level and the second group of transmissions at least at the second adjusted guaranteed power level.

15. The WTRU of claim 14 wherein:
each of the first group of transmissions and the second group of transmissions comprises one or more transmissions having a common transmission characteristic.

16. The WTRU of claim 15 wherein the common transmission characteristic is at least one of: a bandwidth part (BWP), a transmission time interval (TTI), a round-trip time (RTT), a set of physical transmission resources, and a control resource set (CORESET).

17. The WTRU of claim 14 wherein the processor is configured to adjust at least one of the first initial guaranteed power level and the second initial guaranteed power level based on at least one of a previous scheduling activity and one or more previous transmissions.

18. The WTRU of claim 14 wherein the processor is configured to such that the adjusting of at least one of the first initial guaranteed power level and the second initial guaranteed power level is restricted such that the first adjusted guaranteed power and the second adjusted guaranteed power each remain within a range.

19. The WTRU of claim 14 wherein the receiver is configured to receive the first initial guaranteed power level and second initial guaranteed power level in downlink control signaling.

20. The WTRU of claim 19 wherein the downlink control signaling comprises at least one of downlink control information (DCI) and a media access control (MAC) control element (CE).

21. The WTRU of claim 14 wherein the processor is configured to adjust at least one of the first and second initial guaranteed power levels by adjusting the first and second initial guaranteed power levels such that a sum of the first and second adjusted guaranteed power levels remains constant, whereby a remaining power level between the sum of the first and second adjusted guaranteed power levels and the maximum transmit power level assigned for the WTRU remains constant.

22. The WTRU of claim 14 the processor is configured to adjust at least one of the first and second initial guaranteed power levels by adjusting the first and second initial guaranteed power levels such that a remaining power between the sum of the first and second adjusted guaranteed power levels and the maximum transmit power level assigned for the WTRU is variable.

23. The WTRU of claim 14 wherein the processor is configured to adjust at least one of the first and second initial guaranteed power levels by adjusting the first initial guaranteed power level as a function of any one or more of: (1) a power level previously used for transmissions for the first group of transmissions and/or (2) a quantity of previously successfully decoded downlink control information (DCI) for a set of control resources for the first group of the transmissions.

24. The WTRU of claim 14 wherein the processor is configured to adjust at least one of the first and second initial guaranteed power levels by autonomously adjusting the first and second initial guaranteed power levels based on any one or more of: scheduling activity and reception of a DCI.

25. The WTRU of claim 14 wherein the sum of all transmission power for transmissions in the first group of transmissions is equal to the first adjusted guaranteed power level and the sum of all transmission power for transmissions in the second group of transmissions is equal to the second adjusted guaranteed power level.

26. The WTRU of claim 14 wherein the sum of the first and second adjusted guaranteed power levels is less than or equal to the maximum transmit power level assigned for the WTRU.
